(19) United States
(12) Patent Application Publication
(10) Pub. No.: US 2013/0177891 A1
(43) Pub. Date: Jul. 11, 2013

(54) AUDIO-VISUAL LEARNING SYSTEM

(71) Applicant: JOACHIM HAMMERSCHMIDT, Mountain View, CA (US)

(72) Inventor: JOACHIM HAMMERSCHMIDT, Mountain View, CA (US)

(21) Appl. No.: 13/539,529

(22) Filed: Jul. 2, 2012

Related U.S. Application Data
(60) Provisional application No. 61/504,173, filed on Jul. 2, 2011.

(51) Int. Cl. G09B 5/06

(52) U.S. Cl. CPC G09B 5/06
USPC 434/309

(57) ABSTRACT

An audio-visual learning device useful for learning materials such as foreign languages, physics, and chemistry. The audio-visual learning devices include special operating controls that enable a user to playback AV content by segments. Meta data is provided to enhance learning.

### RELATIONSHIP TO OTHER APPLICATIONS

To the extent allowed by law this application claims priority to and the benefit of U.S. provisional application No. 61/504,173 entitled “AUDIO-VISUAL LEARNING SYSTEM,” which was filed on Jul. 2, 2011 for inventor Joachim S Hammerschmidt. That application and any publication are hereby incorporated by reference to the fullest extent allowed by law.

### FIELD OF THE INVENTION

The presently disclosed subject matter is directed towards audio-visual learning devices useful for learning materials such as foreign languages, physics, and chemistry.

### BACKGROUND OF THE INVENTION

For many people mastering a foreign language is an extremely difficult and challenging process. Not only can learning the vocabulary and grammatical rules of a foreign language be difficult, but developing the ability to fluently hear, comprehend and speak a foreign language requires far more than mere rote recitation. Fluent speaking requires the ability to use a language in such a comfortable, natural way that processing the language does not intrude on the message being delivered. However difficult it may be, actually mastering a foreign language can be both personally and financially rewarding.

There are many different foreign language learning tools. Books, flash cards, audio recorders and tapes, video recorders and tapes, computers, classroom instruction, individual tutoring, and language immersion are a few examples of tools commonly used to learn a foreign language. Using many different language learning tools is highly beneficial because language learning is a cumulative process in which new skills are added to old, and in which the old skills become even more useful and natural when new skills are added. Whatever tools are used they work best if the learner actively participates in the learning process. For example, while reading to oneself is helpful, reading out loud is better. While listening is helpful, writing out what was heard is better.

Learning a foreign language is not the only highly challenging learning activity. Medical and veterinary schools frequently teach materials that are both new and complex. Military science, physics, chemistry, architecture and many other fields also require students to learn complex materials such that they become so intuitive that they can be applied and manipulated to provide superior results. Such schools of thought also make use of many of the same learning tools used to learn a foreign language.

Of the many different learning tools available some are particularly well suited to individual study and instruction. Computers and audio-visual (AV) systems can be singled out as being particularly useful for individual study as they can be used at anytime, they are highly flexible, they can be used without any embarrassment to the learner, and they have infinite patience.

Computer-based learning programs are usually designed to operate interactively. Furthermore, modern computer-based learning programs have the ability to implement and integrate AV systems, auxiliary data, and system controls into one common package. Some computer programs can play AV content while also providing additional data and enabling user feedback and interaction. But, such prior art computer-based learning programs are usually not particularly realistic and provide somewhat limited additional new skills for the learner. Prior art computer-based learning programs tend to be more useful in repeating already known information or presenting information that can be easily obtained from other sources.

One of the more interesting ways of learning a foreign language is to watch movies, television programs, news reports, and similar content in the native language. This approach lends itself to “real-life” learning in which the foreign language flows naturally and in a normal context using ordinary dialects, inflections, speeds, tones, pauses, jargon, and other factors. Likewise, learning other materials could benefit from watching AV content that is supplemented by additional information and user interactions.

While learning using movies and other AV content is not new, in the prior art AV content was usually presented on a television or other AV imaging device using an AV player of some sort that was less-than-optimal for learning. For example, while standard AV players provide Forward-Reverse-Pause and Stop capabilities, such is far less then optimal for learning a foreign language wherein fast and easy returning to a specific scene, dialog, or sentence, or skipping to the next desired scene, dialog, or sentence would be highly useful. Furthermore, being able to play AV content in both a standard AV mode and an enhanced learning mode would be useful. In addition, enhanced “user controls” that enable playing, forwarding, fast forwarding, reverse, and fast reverse by scenes, dialogs, sentences, or words would be beneficial. In addition an AV player having enhanced playback controls useful for learning could also benefit by incorporating a timer during periods of non-verbal content along with a control that would enable skipping of the non-verbal content.

Also useful would be an AV device that uses meta data: additional learning data that is presented along with AV content. Being able to select among alternative sets of meta data would be beneficial. An AV learning system that also allows dictation interactions and storing of learner progress information would be helpful.

### BRIEF SUMMARY OF THE INVENTION

The principles of the present invention provide for audio-visual learning devices for playing audio visual content in a manner that is beneficial for learning. Such audio-visual learning devices include memory for storing audio-visual content and meta data as well as a media player having a display. The media player selectively images the AV content as well as user selected meta data. The AV content can be played in a continuous play mode which mimics a standard media player or in an enhanced Stop-and-Go mode. When in continuous play mode the media player implements Forward-Reverse-Pause controls and, optionally, Stop controls for a user. The Forward and Reverse functionality may be present in the form of a slide/progress bar as in state-of-the art software media player applications; there, the user can drag the playback to the desired time location. In the Stop-and-Go mode the media player implements Continuous Play, Segment Play, Play Next Segment, and a Navigation control for a user. Beneficially the Pause control switches the media player from continuous play mode to Stop-and-Go mode, while the Continuous Play control switches the media player from Stop-and-Go mode to continuous play mode. The Play Segment control causes the media player to play a segment of the AV content. Beneficially, in the Stop-and-Go mode AV content and said meta data are played by segments.

An audio-visual learning device can be implemented either completely or partially on a computer, such as a laptop computer, a desktop computer, or a tablet computer. Suitable input devices include mice, keyboards, and touch screens or audio with appropriate speech-to-text converter. An audio-visual learning device can also be implemented either completely or partially using a television, beneficially one with a remote control, or a game box. Usefully an Audio Visual Learning device can make use memory distributed over internet.

Meta data can include segment numbers, time stamps, timers, subtitle tracks such as translations and closed-captions or other transcription of AV content, phonetic transcriptions, and additional information related to the AV content such as its difficulty. Meta data can be output in one or more text boxes and can be input using a keyboard, beneficially a soft keyboard such as those on touch screens. Special meta data controls such as segment selectors, meta data selectors, slide controls, skip controls, information controls, and typing controls are beneficial.

Preferably AV content is comprised of a plurality of compressed data frames in which all segments start on an I-frame. Beneficially starting segments are synchronized with conversation markers.

### BRIEF DESCRIPTION OF THE DRAWINGS

The advantages and features of the present invention will become better understood with reference to the following detailed descriptions and claims when taken in conjunction with the accompanying drawings, in which:

FIG. 1 depicts alternative personal computer systems suitable for implementing the principles of the present invention;

FIG. 2 illustrates a representative tablet computer suitable for implementing the principles of the present invention;

FIG. 3 illustrates a representative AV system having a television display, a computational device, and a touch screen remote control and which is suitable for implementing the principles of the present invention;

FIG. 4 presents a high-level state diagram of an Audio-Visual Learning Device (AVLD) illustrating operation in two play modes: “Continuous Play” and “Stop-and-Go”;

FIG. 5 presents a high-level state diagram of a “Stop-and-Go” mode of operation;

FIG. 6 presents a high-level state diagram of an alternative “Stop-and-Go” mode of operation;

FIG. 7 presents a high-level state diagram of another alternative “Stop-and-Go” mode of operation;

FIG. 8 illustrates a meta data table suitable for an AVLD that is in accord with the principles of the present invention;

FIG. 9 depicts count-down information and a user control that is useful during non-verbal segments;

FIG. 10 depicts a representative scene and operating controls during the continuous play mode of an AVLD device that is in accord with the principles of the present invention;

FIG. 11 depicts a representative scene, subtitle track, and user controls at the start of a Learning Segment in a Stop-and-Go mode of an AVLD that is in accord with the principles of the present invention;

FIG. 12 depicts a representative scene, subtitle track, and user controls at the end of a Learning Segment in a Stop-and-Go mode of an AVLD that is in accord with the principles of the present invention;

FIG. 13 depicts a representative scene, various user controls, and a typing playback text box of an AVLD in a dictation mode;

FIG. 14 depicts representative “soft” keyboards on a touch screen of an AVLD in dictation mode;

FIG. 15 depicts representative context subtitles in a AVLD device that is in accord with the principles of the present invention;

FIG. 16 illustrates navigation using context subtitles;

FIG. 17 depicts the selection of subtitle-tracks by tapping an icon on a touch screen;

FIG. 18 depicts a method of selecting words for translation or retrieval of other related information;

FIG. 19 depicts retrieval of additional meta data using an operating control icon;

FIG. 20 illustrates one possible relationship between a media player and memory components of an AVLD that is in accord with the principles of the present invention;

FIG. 21 illustrates an alternative relationship between a media player and memory components of an AVLD that is in accord with the principles of the present invention;

FIG. 22 illustrates yet another alternative relationship between a media player and memory components of an AVLD that is in accord with the principles of the present invention;

FIG. 23(a) illustrates representative MPEG-4 frames without frame processing;

FIG. 23(b) illustrates MPEG-4 frames after frame processing in accord with the principles of the present invention;

FIG. 24 illustrates offline processing of MPEG-4 frames in accord with the principles of the present invention;

FIG. 25 presents a generalized high-level state diagram of the “Stop-and-Go” mode of operation.

FIG. 26 is a more detailed state flow diagram showing transition between the main system states.

FIG. 27 illustrates overlapping segments and ramping up and/or ramping down selected playback parameters such as volume during playback of overlapping segments.

FIG. 28 illustrates details of overlapping segments and an alternative embodiment of the ramp-up mechanism shown in FIG. 27; and

FIG. 29 illustrates another scenario in which AV content is played back on a TV or computer screen while user controls and/or context subtitles are operated using a remote handheld device.

### DETAILED DESCRIPTION OF THE INVENTION

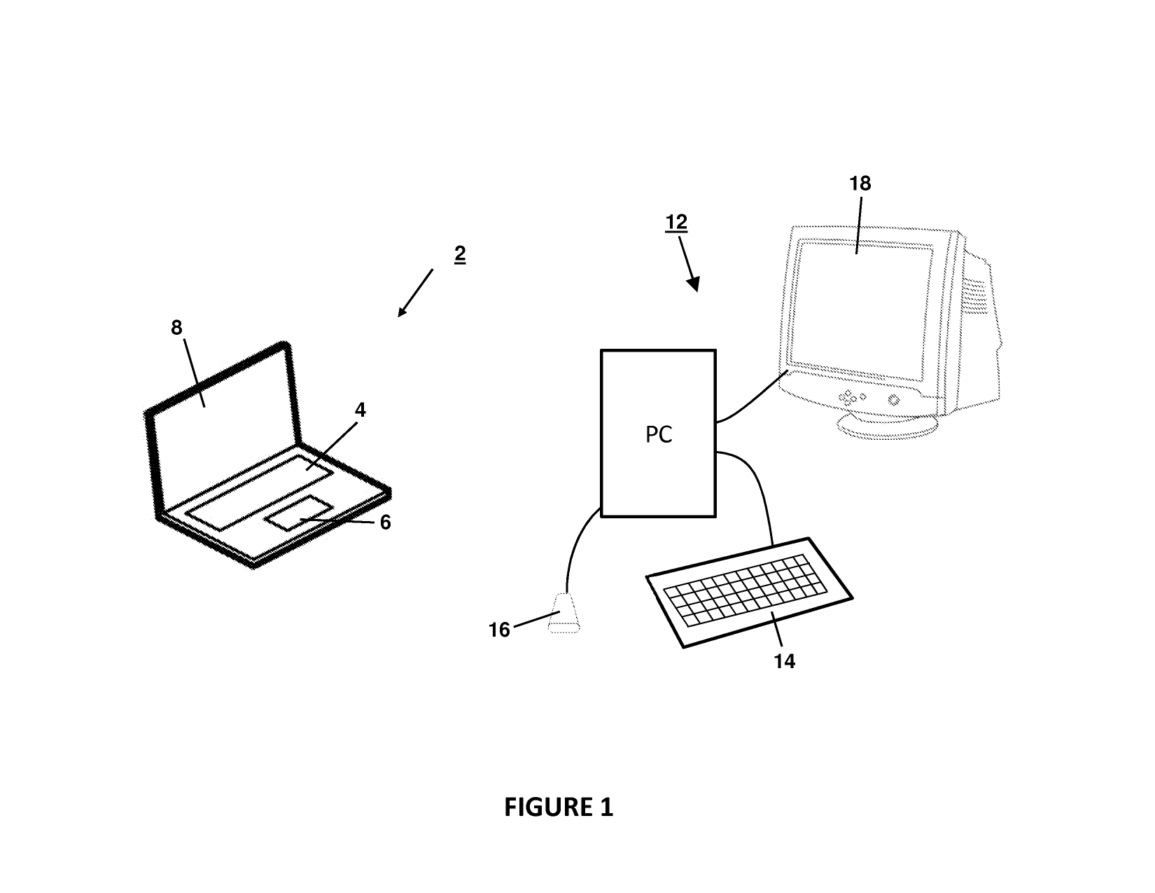

The principles of the present invention will be described hereinafter with reference to the accompanying FIGS. 1 to 29 in which multiple alternative embodiments of devices and methods in accordance with the principles of the present invention are shown. However, it should be understood that this invention may take many different forms and thus it should not be construed as being limited to the specific embodiments illustrated and set forth herein.

All publications mentioned herein are incorporated by reference for all purposes to the extent allowable by law. In addition, in the figures like numbers refer to like elements throughout. Additionally, the terms “a” and “an” as used herein do not denote a limitation of quantity, but rather denote the presence of at least one of the referenced items.

The principles of the present invention provide for novel, useful, and non-obvious Audio-Visual Learning Devices (hereinafter referred to individually as “AVLD”) that implement methods and systems for learning using Audio-Visual (AV) content. In some embodiments AV content is supplemented with additional useful learning information that is generically referred to as meta data. Examples of meta data would be sub-titles for AV content or explanatory information presented in a text box (other examples of meta data are provided below). While the inventive methods and systems can be implemented using a wide variety of hardware, software, and firmware, any device or set of devices that implement the principles of the present invention will be generically referred to as an AVLD.

An AVLD will have a display for viewing AV content (and possibly meta data), a set of user inputs or controls for interacting with the AVLD, and memory to retain AV content and possibly meta data. Interactions with an AVLD include not only controlling the operation of the AVLD device but also inputting information such as foreign language text. User Inputs may be made by a keyboard, a touch screen, a computer mouse, a trackpad, a microphone, or by another input device.

FIG. 1 illustrates two personal computer systems suitable for implementing an AVLD: a laptop computer 2 and a desktop computer 12. The laptop computer 2 includes a keyboard 4 and a touchpad 6, both of which are useful for interacting with the AVLD, and a display 8 for viewing AV content and meta data. The desktop computer 12 includes a keyboard 14 and a mouse 16, both of which are useful for interacting with the AVLD, and a display 18 for viewing the AV content and meta data. While the foregoing described are personal computers, AVLDs are not limited to personal computers. Mainframes, distributed, virtual, remote, and other types of computers can also be used to implement an AVLD.

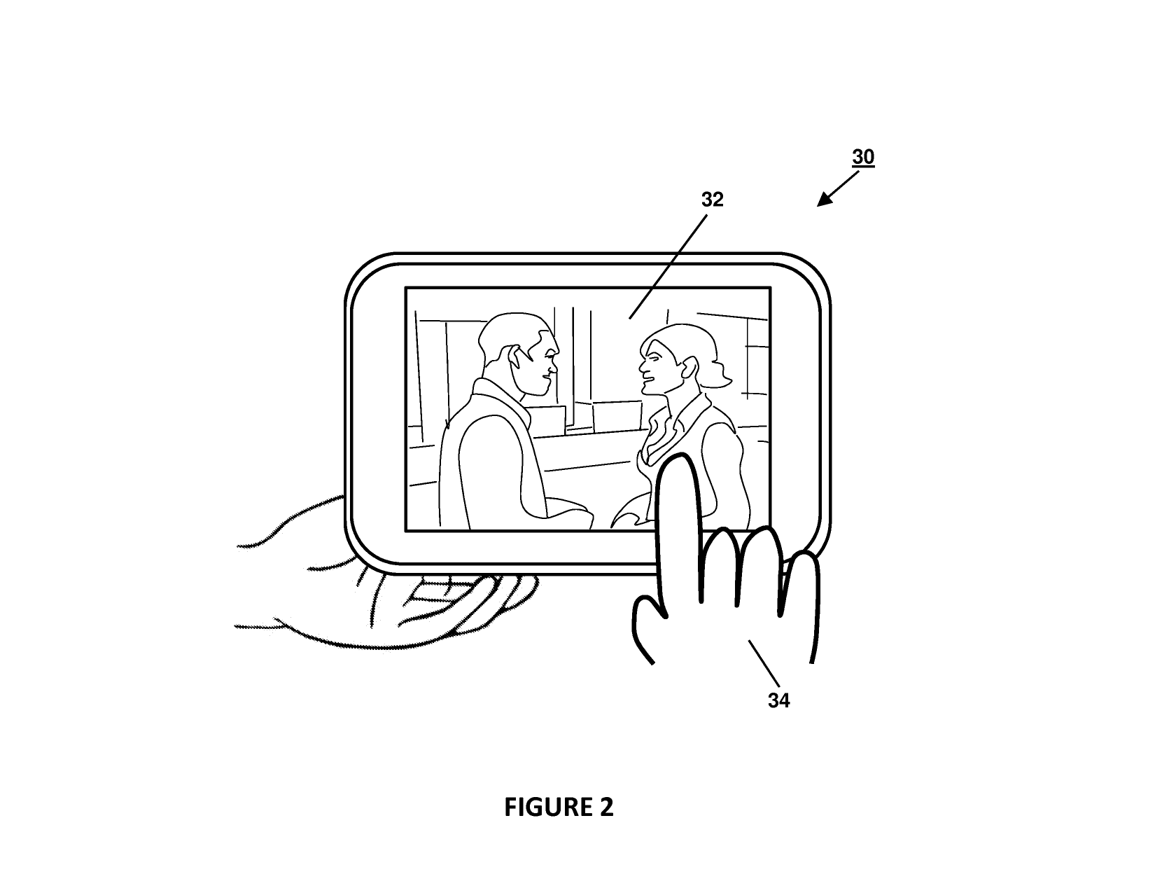

Another system well suited for implementing an AVLD is a tablet computer 30, reference FIG. 2. The tablet computer 30 has a touch screen 32 that is not only used to view AV content and meta data but also as an input that enables a user 34 to interact with the AVLD. In some respects a tablet computer 30 with a touch screen 32 user interface is preferred over a traditional personal computer when implementing AVLDs because the touch screen 32 of a tablet computer 30 or a smart phone lends itself to displaying foreign characters and soft-keyboards with special characters that are not readily available on traditional keyboards.

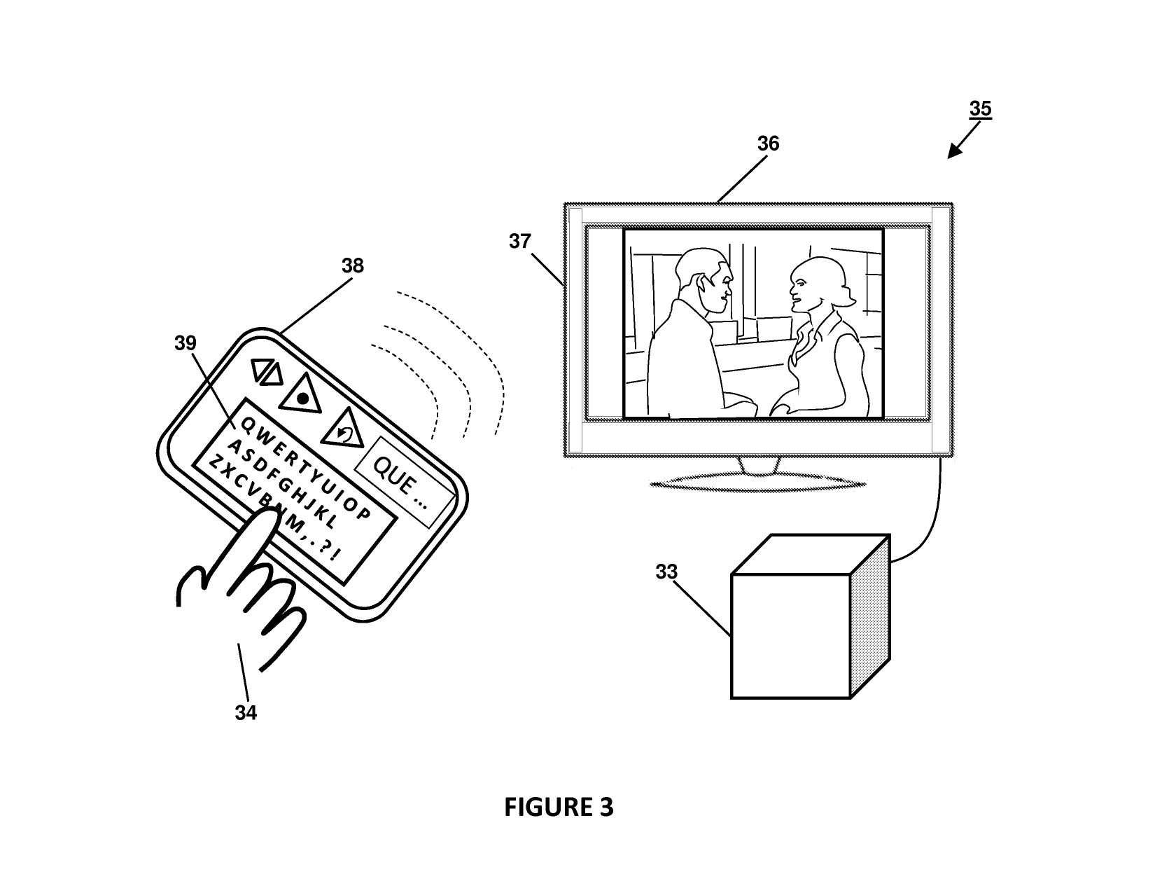

FIG. 3 shows yet another system 35 suitable for implementing an AVLD. That system 35 uses a television 36 having a screen 37 and a remote control 38. The remote control 38 beneficially includes a touch screen 39 that implements features such as various keyboards and player control icons that enable a user 34 to interact with the AVLD. The remote control 38 could be a touch screen device such as a smart cell phone (such as the Apple iPhone or an Android touch-screen phone) or a tablet computer 30 such as the Apple iPAD (see FIG. 2). The system 35 is also shown as including a computer box 33. That computer box 33 could be a game box (Sony, X-Box), a set-top box, an internet connection, an intranet connection, a specialized device specifically fabricated for the AVLD, or any number of other devices. Furthermore, in some embodiments the computer box 33 would not be used if the remote control 38 and/or television 36 implement the required computational and memory requirements of an AVLD.

It should be noted that the configuration with two physical devices exhibiting screens (here: the remote device 18 shown in FIG. 1 and the TV display 37 shown in FIG. 3) lends itself to various embodiments of distributing components between these devices. For instance, in one embodiment the TV device 36 with its screen 37 could merely be the recipient of AV content that is transmitted by the remote device 38 and the only task of the TV 37 is to display this AV content, while the remote device 38 performs all other tasks. In another embodiment, the TV 36 or the connected compute box 33 carry out all major tasks, and the only interaction with the remote is to wirelessly transmit from the TV 36 (or compute box 33) to the remote device 38 the information to be displayed on the screen of the remote device 38; in that configuration, any user inputs will simply be transmitted back wirelessly from the remote device 38 to the TV 36 or compute box 33 for further processing.

From the foregoing it should be obvious that AVLDs can be implemented in a very wide variety of hardware, software and firmware configurations using existing and/or specialized hardware and software. It should be clearly understood that AVLDs can make use of internet and intranet connections. In fact locating AV content and meta data and/or all or parts of the media player on one or several remote servers of some sort is highly beneficial it enables easy updating and distribution of content. Additionally, using wireless communications between remotes, mice, tablets, computers, and displays is also beneficial as such reduces set-up and operational problems and enhances user convenience.

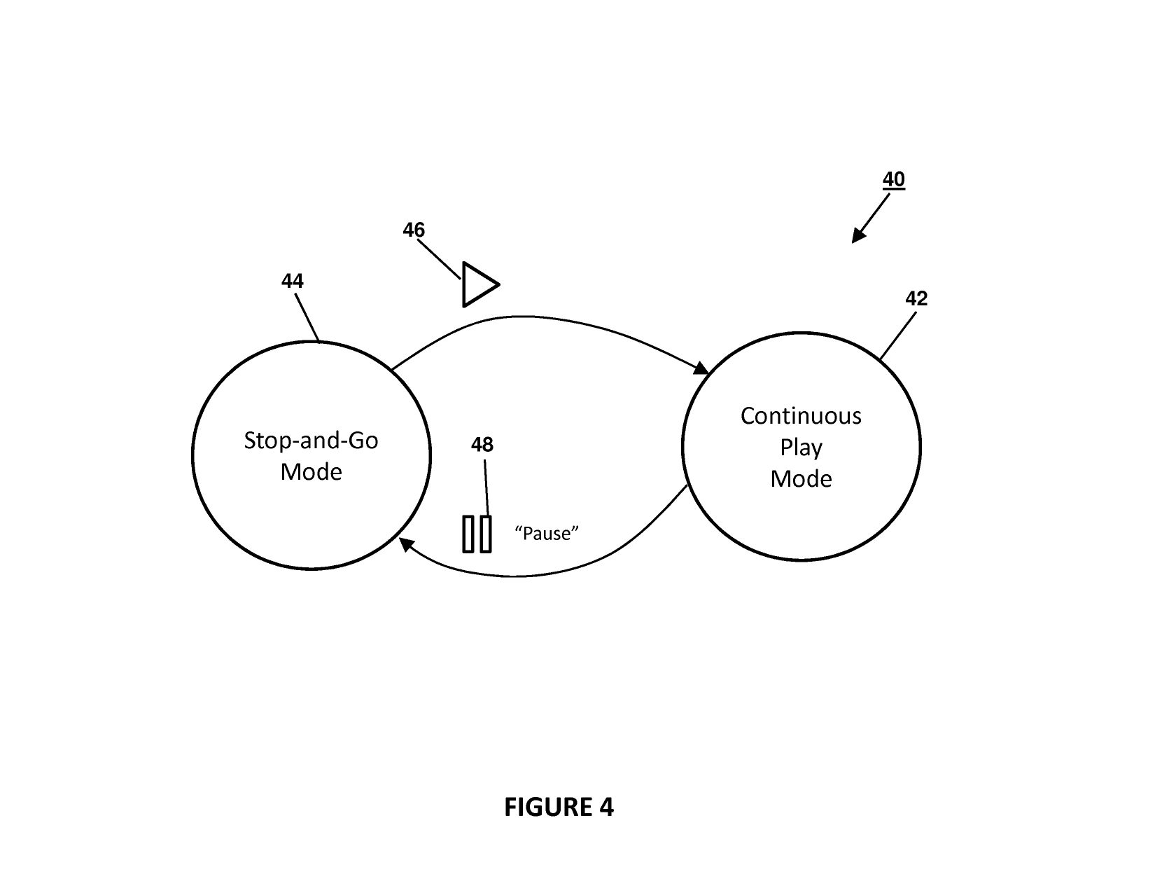

Most AVLDs in accord with the principles of the present invention will operate in at least two different modes: a “Continuous Play” mode and a “Stop-and-Go” Mode. FIG. 4 illustrates a top level state diagram of an AVLD 40. In the Continuous Play mode system state 42 the AVLD 40 acts primarily as a conventional AV player in which AV content is played from beginning to end unless a user interacts with the AVLD using conventional playback controls. In traditional devices such as DVD Players, conventional playback controls include Play, Pause, Stop, and Fast-Forward/Reverse Controls. In more recent devices, including software based players, there may not be a Stop button, and the Fast-Forward/Reverse controls are replaced by a slide/progress bar. A slide/progress bar is usually a small visual element such as a rectangle moving over a horizontal line. The position of that visual element illustrates the playback position, and the user can relocate the playback position by moving the visual element with the mouse (or finger on a touch screen). Due to the digital nature of modern video players in contrast to mechanical devices such as tape recorders or DVD/CD players, a Stop control is no longer required.

As shown in FIG. 4, the AVLD 40 enters the Continuous Play mode system state 42 from a Stop-and-Go-mode system state 44 when a user activates (such as by using a mouse, touch screen, physical button, etc.) a Continuous Play button 46. The AVLD 40 also has a Pause control 48 that initiates a transition to the Stop-and-Go-mode system state 44. In many conventional AV players, when a Pause button is activated the player halts AV playback and resumes playback when the Play Button is pressed. However, the AVLD 40 operates somewhat differently. The Pause control that transitions from Continuous Play mode to Stop-and-Go mode and the “Continuous Play” control that transition from Stop-and-Go mode to Continuous Play mode can share the same position on a screen by merely changing the shape of the control element on the screen.

Still referring to FIG. 4, when the Pause control 48 is activated the AVLD 40 moves to the Stop-and-Go-mode system state 44. This activates additional features that are discussed subsequently. However, if the Continuous Play button 46 is activated again system operation reverts to the Continuous Play mode system state 42 and the AV content continues, thus mimicking what would occur in a conventional AV player. It should be understood that in Continuous Play mode system state 42 that standard player controls such as “Stop,” “Forward,” “Fast Forward,” “Reverse,” and “Fast Reverse,” or, equivalently, a slide/progress bar, are available to the user.

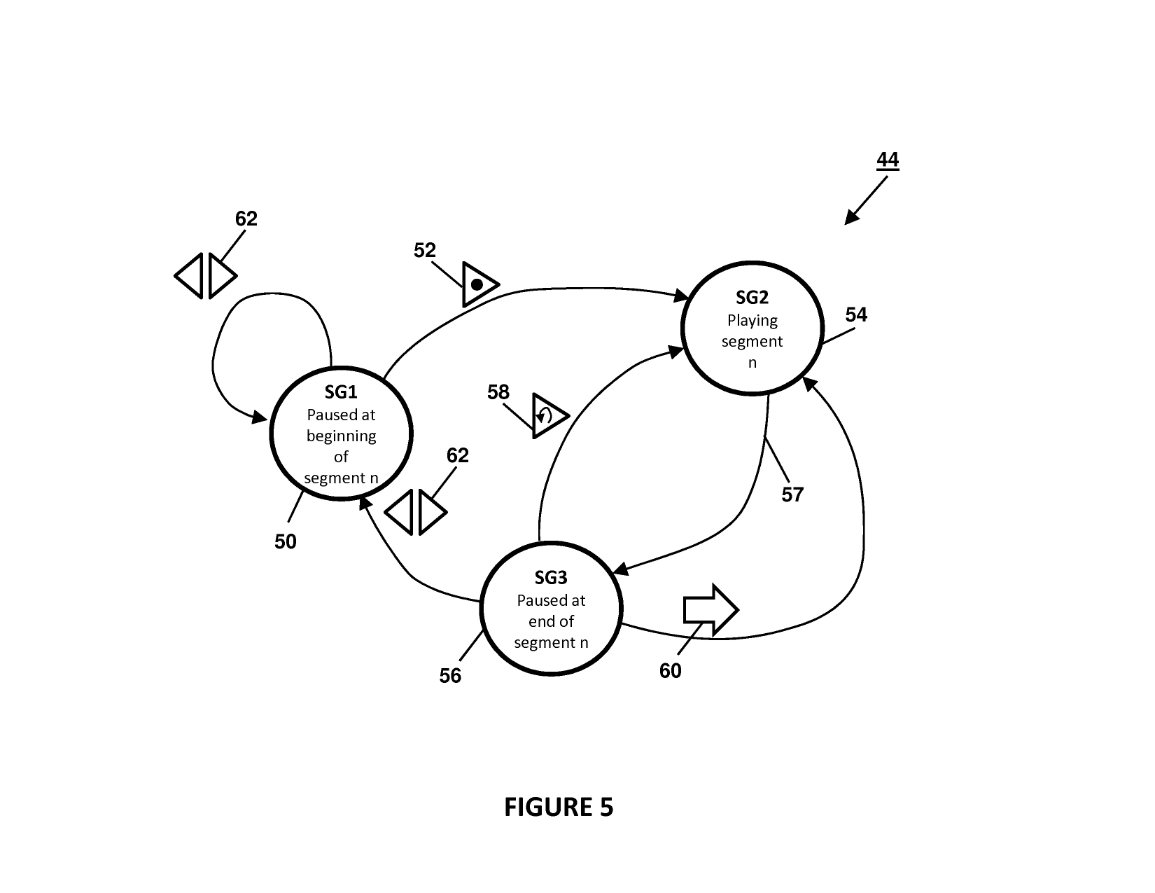

Turning now to FIG. 5, the Stop-and-Go-mode system state 44 is described with the aid of a possibly lower level (albeit still relatively high level) depiction. The illustrated Stop-and-Go-mode system state 44 is assumed to begin in SG1 system state 50 with the AVLD 40 being paused at the beginning of a current learning segment referred to as segment n. The first video image of segment n is displayed as a still image on the screen. A learning segment is defined as one contiguous piece of AV content along with additional meta data that is associated with that AV content (subtitle information or explanatory details). For convenience, learning segments will be referred to as (1, 2, 3, . . . n, n+1, n+2, . . . N). In many cases, but certainly not all, playback will occur sequentially. For purposes of explanation the current learning segment is segment n. As an example of a learning segment, if the AVLD 40 is designed to be used to learn a foreign language a learning segment might be a scene, a dialog, a paragraph, piece of a paragraph, a sentence, or even a word that is used to teach the foreign language.

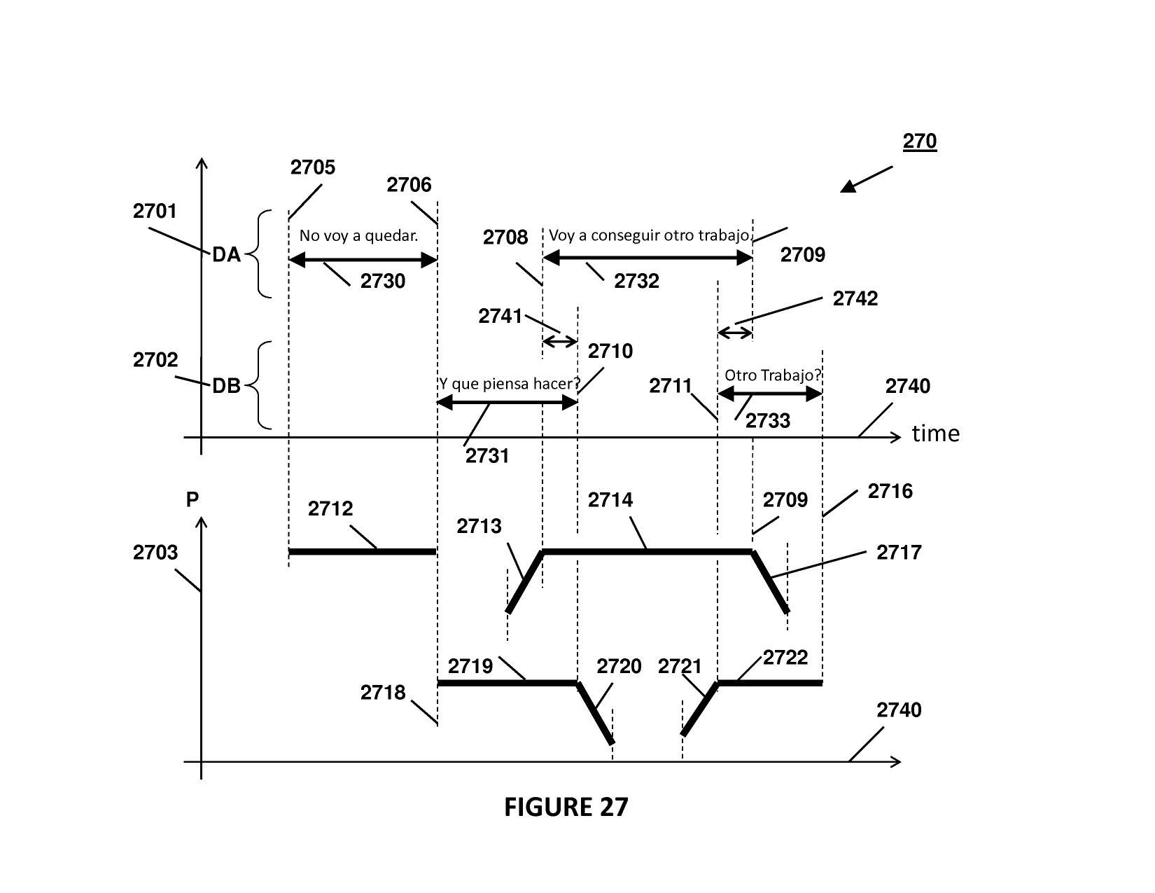

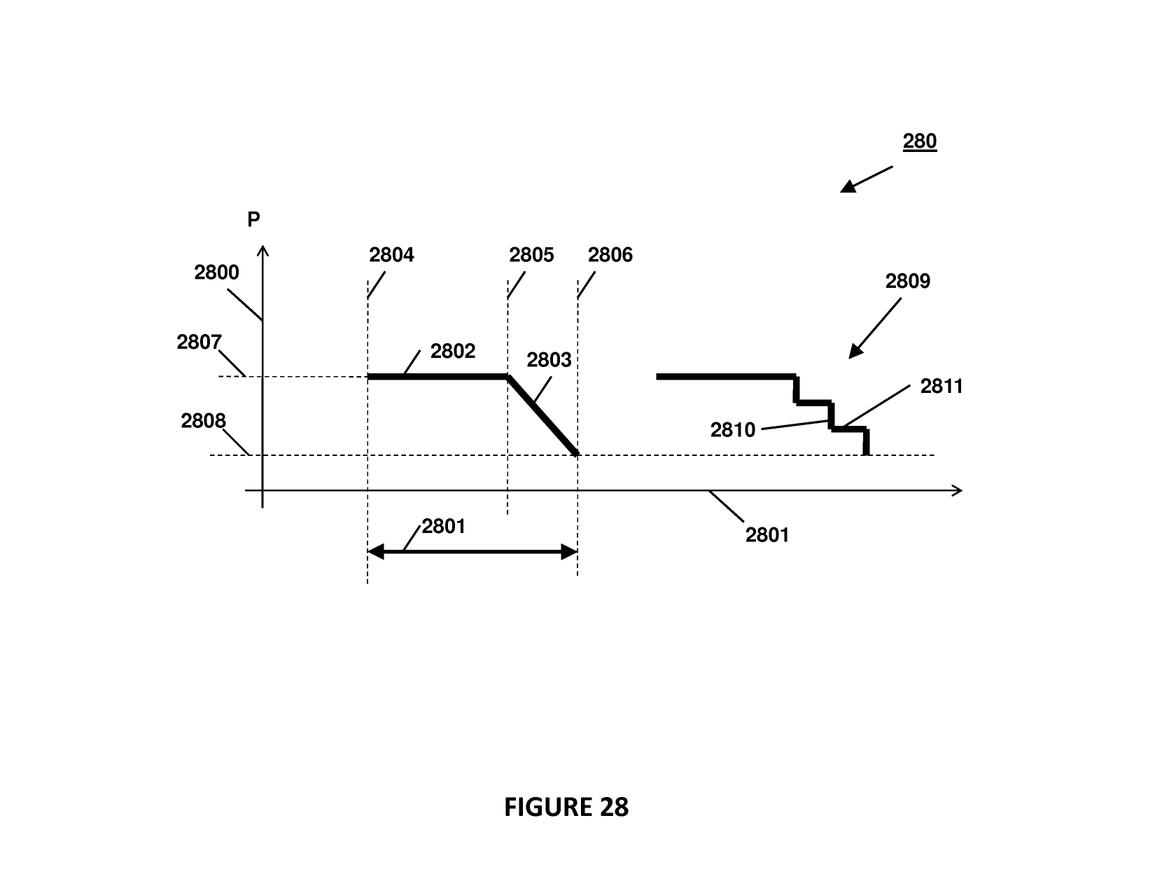

It should also be understood that learning segments can overlap in time. For instance, segment n can be a contiguous piece of AV content corresponding to a sentence spoken by a first person in the audio-visual content. Segment n+1 can correspond to a sentence spoken by a second person in the audio-visual content, but that sentence can start while segment n is still in progress. Then segment n can be defined as the content covering the first person's speaking from beginning to end, which may include an early part of the second person's sentence. Also, the subsequent segment n+1 can then be defined as the content covering the second person's speaking, which may contain a late part of the first person's sentence. This is explained in greater detail with referenced to FIGS. 27 and 28.

Still referring to FIG. 5, beneficially the subtitle information for at least segment n will be displayed. This enables the user 34 to readily identify the information being presented in segment n. As described in more detail subsequently, there may be multiple tracks of subtitle information for each segment. For example, if segment n is being used to learn a foreign language the subtitle information might be a foreign language subtitle, or so-called Closed Caption, in the foreign language (thereby assisting to read a foreign language), an English language subtitle (thereby assisting translation), translation into another language such as the mother tongue of a non-English speaker, a phonetic subtitle (thereby assisting learning pronunciations of foreign words), context information (to provide a context for the segment), or any other information that may be useful to learn the content of segment n.

To playback segment n, a user presses a specialized user interface Play Segment control 52. This activates the Play Segment control 52 causing the AVLD 40 to transition to SG2 system state 54. While having a user 34 activate a control to initiate a state transition is contemplated in some AVLDs there can be less explicit ways to trigger state transitions (such as by a remote instructor control, automatically, time delays, interaction with context subtitles discussed below, etc).

When in SG2 system state 54 the AVLD 40 automatically plays back segment n, beneficially until segment n ends. Upon reaching the end of segment n the AVLD 40 automatically transitions into SG3 system state 56. In SG3 system state 56 the AV content is paused at the end of segment n. That is, the last image before the subsequent learning segment n+1, is displayed until another AVLD 40 control input or signal is received.

Still referring to FIG. 5, in SG3 system state 56 a plurality of specialized user input controls are made available to the user. If a user activates a Repeat Segment Control 58 a transition is made back to SG2 system state 54 and segment n is repeated. If a user activates a Play Next Segment control 60 a transition is made back to SG2 system state 54 and segment n+1 is played. However, if a user activates a Navigation/skip control 62 (two such controls 62 are shown in FIG. 5, but it should be understood that they are the same control that can be activated in different system states) a transition is made back to SG1 system state 50. The AVLD 40 then navigates to find the desired learning segment to be played. Note that Play Next Segment controls 52 and 60, which are used during different system states, are one and the same control element in a preferred embodiment.

In one embodiment, activating a left navigation triangle of the Navigation/skip control 62 will first cause a transition from segment n to segment n−1; that is, the former segment n−1 will become the new segment n, and the AVLD will make the previous learning segment active. Continued clicking of the left navigation triangle steps back one learning segment at a time. However, continuous activation of the left navigation triangle of Navigation/skip control 62 causes faster and faster backward stepping of learning segments. Similarly, activating the right navigation triangle of the Navigation/skip control 62 will make a transition from segment n to segment n+1. Continued clicking of the right navigation triangle steps forward one learning segment at a time. However, continuous activation of the right navigation triangle causes faster and faster stepping forward of learning segments. Once you are in SG1 system state 50 activating the Navigation/skip control 62 causes the same functioning as described above. Different versions of the Navigation/skip control 62 are possible, such as controls that allow larger skip distances to be accomplished with a single activation of the control. For instance, controls can be provided to skip to the beginning of the preceding or subsequent dialogue or scene.

It should be understood that the user controls available in the Stop-and-Go mode 44, such as the Navigation/skip controls 62 or the Play Segment control 52, may be present during the Continuous Play mode 42. They will, however, assume slightly different roles then. If a Navigation/skip control 62 is activated while in Continuous Play mode 42 the playback position will skip to the beginning of the previous segment, or the next segment depending on the skip direction. Playback will then continue without interruption at the new playback position. Similarly, if the Stop-and-Go mode 44 is in progress and a control targeted for Continuous Play mode 42 is activated, such as a conventional Fast Forward and a Reverse or a user moving a slide/progress bar, the playback position is relocated to a new segment in the desired location, while the system will stay in the Stop-and-Go mode 44.

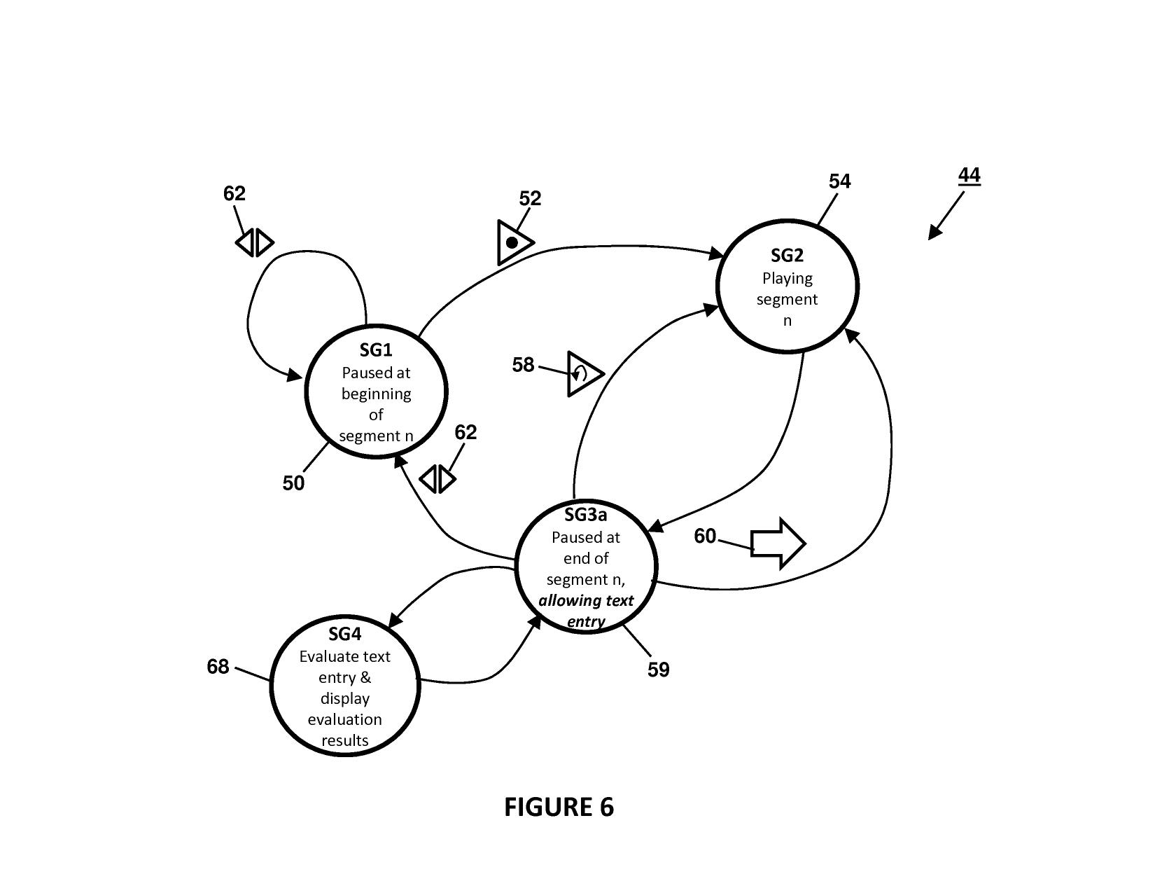

The AVLD 40 is further capable of additional functionality. For example FIG. 6 illustrates an alternative Stop-and-Go-mode system state 44, which is similar to that illustrated in FIG. 5 but with enhanced capabilities to enable user text entry. When the AVLD 40 is in SG3a system state 59, which is an enhanced state SG3 from FIG. 5, the AVLD presents the user with the task of typing in keyboard information. This is referred to herein as a “dictation” mode which is entered by a transition to SG4 system state 68. For example, if the AVLD 40 is being used to learn a foreign language and dictation mode is enabled, the AVLD 40 automatically brings up a text entry field for text entry and prompts the user 34 to enter the verbal information that he/she heard in the current learning segment. Once the text has been entered, the AVLD state transitions from SG3a system state 68 to SG4 system state 68-59. In dictation mode the listening and spelling skills of the user 34 in the foreign language are actively trained and verified. The user 34 will attempt to type in the words he/she hears in SG2 system state 54.

Once the user 34 has typed the textual information he/she has heard in the segment n, he will send the typing information for evaluation by pressing a button such as “Enter” on the keyboard. This causes a transition from state SG3a to state SG4 where an evaluation of the correctness of the typed information is displayed. After user confirmation, the system automatically transitions AVLD 40 from SG4 system state 68 back to SG3a system state 59. The results of the dictation mode can be stored for progress tracking (discussed in more detail subsequently). If the user has difficult hearing the spoken content for typing, he/she can repeat the segment at will using the Repeat control 58.

As previously noted, using a touch screen tablet computer (reference FIG. 3) is particularly useful because of the ease in which foreign language keyboards and specialized keys can be implemented. Another useful example would be using the touch screen to enter mathematical symbols and formulas such as when the AVLD 40 is used for physics, engineering, chemistry, or mathematical instruction.

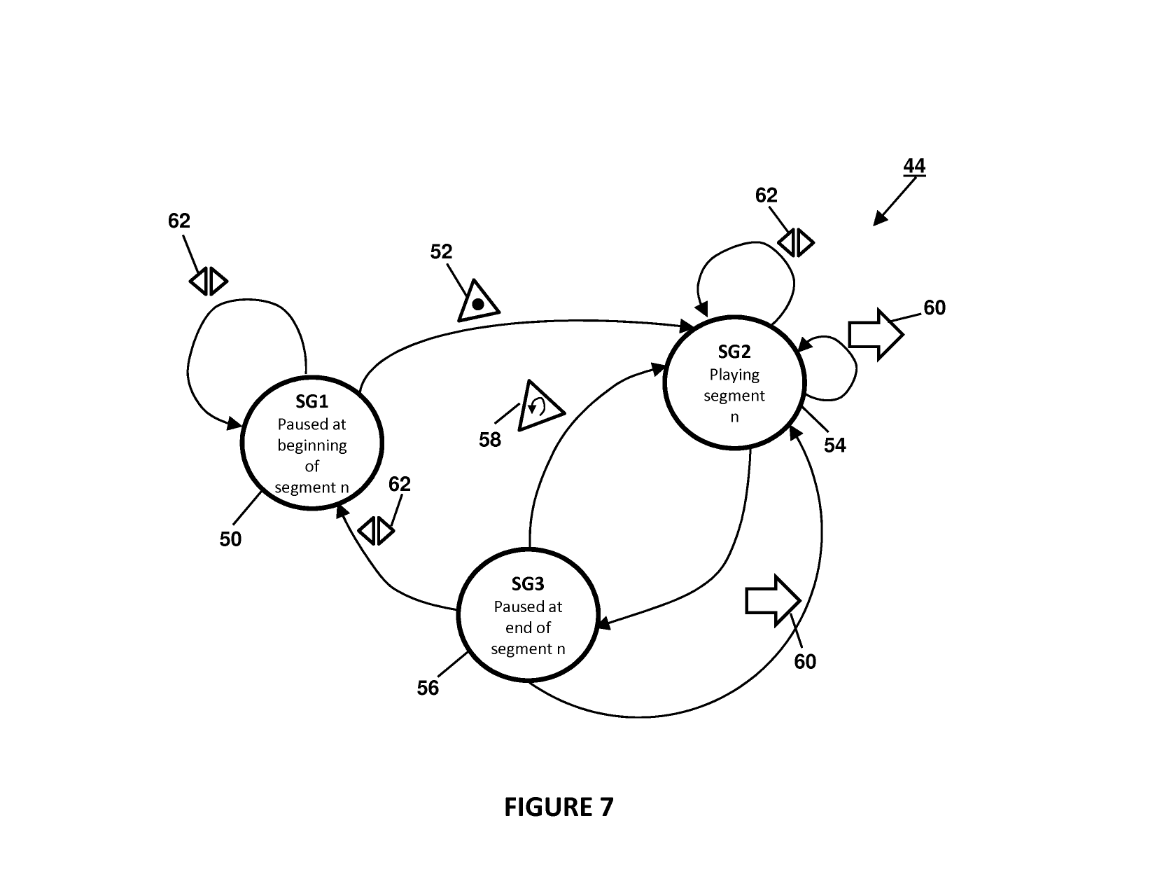

It should be understood that AVLD 40 is capable of additional functionality. For example, FIG. 7 adds extra user navigation controls to SG2 system state 54. The extra navigation controls include the Play Next Segment control 60 (previously accessible from SG3 system state 56 and SG3a 59) and the Navigation/skip control 62 (previous accessible from SG1 system state 50, SG3 system state 56, and SG3a 59). Again, in a preferred embodiment the controls 60 and 52 that play the next segment will use the same user control element. Accessing these controls from SG2 system state 54 is convenient when segment n is a “Non-Verbal” learning segment, that is, a learning segment without spoken language. The user 34 can then easily skip to subsequent or previous learning segments while the Non-Verbal segment is being played back in SG2 system state 54. In some applications transitioning from segment n to another learning segment will not cause immediate playback of the new segment in state SG2, but instead cause a transition into a paused mode in SG1 system state 50.

The foregoing introduced the concept of meta data: information outside of the AV content itself that is useful for learning. Meta data comprises information such as time-stamp information and various subtitle tracks that can be applied to each learning segment. It should be understood that meta data can be information from different places than the AV content. For example, AV content might be stored local to a playback system while the meta data might be downloaded over the internet. Meta data and AV content are different.

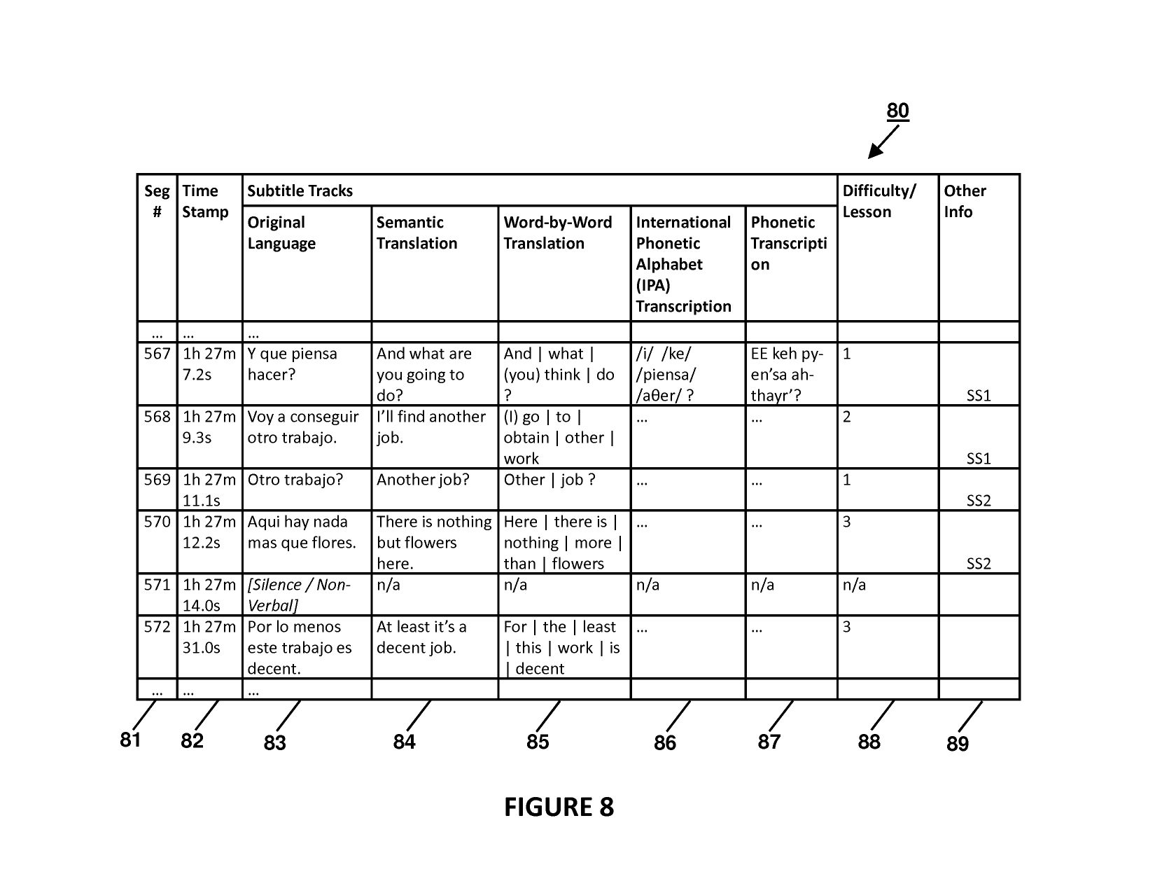

FIG. 8 presents a prototypical table 80 of possible and useful meta data information. As shown therein each learning segment is numbered, reference column 81. Each learning segment begins at a time provided by a time stamp, reference column 82. For example, in FIG. 8, Segment 568 (n=568) refers to AV content that starts at 1 hour 27 minutes and 9.3 seconds from the beginning to just before the next time stamp at 1 hour 27 minutes and 11.1 seconds.

Meta data can further include things such as subtitle information. A subtitle may comprise a textual representation of the spoken content in a given learning segment. That might be the traditional subtitles (closed captions or translations) used in a foreign language movie, reference column 83; a semantic translation into the user's mother language, reference column 84; a word-by-word translation, reference column 85; an international phonetic transcription, reference column 86; or a simple phonetic transcription, reference column 87. Note that there can be many different subtitle tracks in meta data. For instance, there can be subtitle tracks representing semantic translations (translations optimized to express the meaning of the original content), or more direct word-by-word translations for various user mother tongues. Depending on the user's mother tongue (which might be selected using a high-level user interface control), only a subset of subtitle tracks may be offered to the user at any given time, namely those most appropriate for the user based on his specified mother tongue or linguistic skills in general.

Meta data can also contain additional information. For example, each learning segment's meta data might also contain an indication of the measure of difficulty, reference column 88 which provides a gauge of the complexity or difficulty of the learning segment. Alternatively, in place of difficulty “lesson information” (such as lesson 1, 2, 3) that connects each learning segment to one or more lessons may be included in the meta data, again reference column 88. In that case the AVLD 40 can then be directed (using a user control) to selectively play only learning segments associated with a selected difficulty or lesson and thereby automatically skip all segment not belonging to the specified difficulty or lesson when the system is in Continuous Play mode, or when the system is in Stop-and-Go mode and the Play Next Segment control 52 (or 60) is activated.

The manner of storing meta data in general and subtitle information in particular can be of particular importance. Subtitle information can simply be stored in the same storage alongside AV Content. In that case the subtitles are similar to “closed captioning” tracks. However, preferably meta data (which can include the subtitle track information) is stored as part of a table 80 which is part of a data-base. This is beneficial because State-of-the-Art data-bases are usually based on a standardized database language such as SQL (Structure Query Language). Such standardized database languages implement the roles of a Data Description Language, a Data Manipulation Language, and a Query Language and enable rapid database searches

If the table 80 is part of a database a segment can be a database table row and the columns 81, 82, etc., can be database table columns Then by using a database query (such as a SELECT in the SQL language), a media player application can easily retrieve meta data for a desired segment to be played back next or can obtain a list of segments that fulfill certain criteria for selective playback, such as segments belonging to a certain difficulty level, exhibiting certain grammatical constructs, include an occurrence of specific words in a subtitle track, or other selection criteria. The media player can then time-synchronize segment playback of AV content using queries and information retrieved from the database.

In one preferred embodiment the AV Content contains conversation markers that enable the media player to retrieve subtitle information for a desired next segment using a database query. If the order of segment play back is controlled by the user 34 using navigation controls or playback controls the media player will be able to request the meta data for the next desired segment n by sending a SELECT request to the database to retrieve the desired meta data information.

In a database table embodiment the meta data, represented by Table 80 that data can be stored as one or more database tables which can also contain a column representing pointers to the AV Content that corresponds to a given segment. For instance, a media player could receive a user input from the user 34 to play-back a desired segment n. By sending a query to the database based meta data, the media player receives the requested subtitle information for segment n, along with a pointer to the AV content representing the next segment to be played back. That information is used by the media player to request the AV Content for the desired next segment from the AV Content storage. The main flow control takes place between the meta data, the media player, and the User Inputs, while the AV Content will be retrieved and played back on an as-needed basis.

It should be noted that progress status can also be implemented as a table in a database.

Beneficially meta data can be established, updated, or improved by a user community. For instance, if AV content is made available on an internet website, the members and/or users of that website may be allowed to add subtitle tracks to the Table 80. For example, someone might provide a correct pronunciation, a new or alternative translation, or add cultural information about the AV content. This allows the meta data to improve and grow over time. Ideally the content of the Table 80 is made available for editing by qualified users.

It should be noted that the meta data may not be exclusively based on textual information. There may also be extra audio information for each segment. For instance, for spoken context that is hard to hear there may be additional audio information intonating the same spoken content as in the original AV Content, but with a clearer, standardized pronunciation for additional learning effects.

Meta data may also contain additional information, reference column 89, such as mathematical formulas, molecular representation, cultural information, linguistic facts that may be useful to the user when viewing a learning segment.

It should be understood that learning segments can be “Non-verbal Segments” (NV Segments). An NV learning segment is one that does not contain spoken linguistic content or that contains spoken content deemed inappropriate for learning. Thus the AVLD 40 may well encounter silence periods. A user control can be added so that short silences between learning segments, such as spanning up to a small number in seconds, can be added to the current, previous or subsequent learning segments. Silence periods can be highly useful when the visual content is more important than sound. Such periods of silence, especially when such periods exceed a certain minimum length such as a few seconds, can be marked as NV learning segments in meta data.

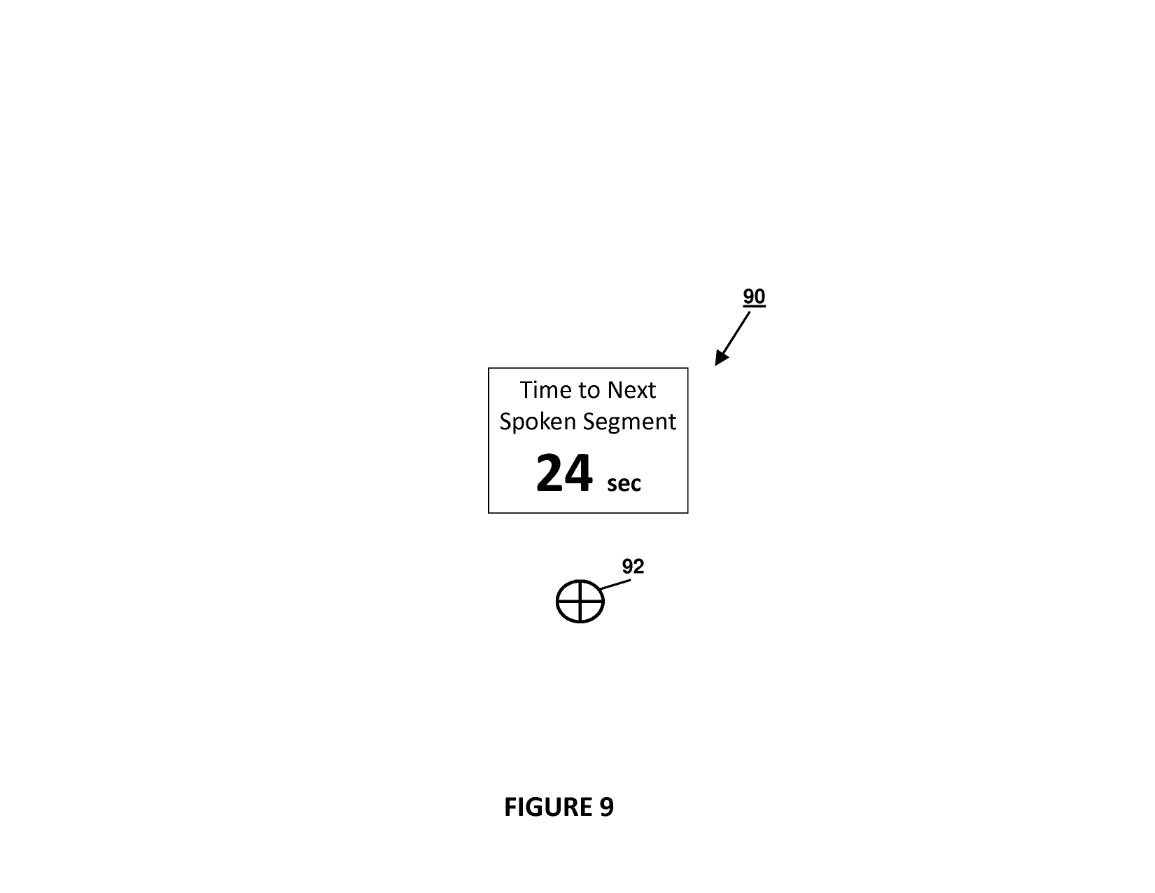

In some AVLD devices a countdown timer can be displayed that shows how long the periods of silence will last, reference timer 90 in FIG. 9. To help the user skip over NV learning segments a user skip control 92 that causes the NV learning segment to end can be added as in FIG. 9.

Referring now back to FIG. 8, segment n=571 is a NV learning segment. As shown no subtitle data is available. In an alternative embodiment scene description information can be contained in the meta data Table 80 and displayed on the screen, such as “Person A walks to the other side of the room”. This provides additional learning material in segments where there is no verbal content.

In yet another embodiment, such scene descriptions for each segment are provided as an additional subtitle track that can be selected by the user 34 on a screen not only during NV segments, but any segment. This presents additional learning experiences for the user 34 by matching up observation of, for instance, a child picking up a ball from the ground, while a scene description subtitle “child picks up ball from the ground” is displayed. Context subtitles may be similar in form and content to a film script. In fact subtitle track may be selected by the user 34 to take the form of a film script containing a mix of spoken subtitle information and scene descriptions depending on the segment.

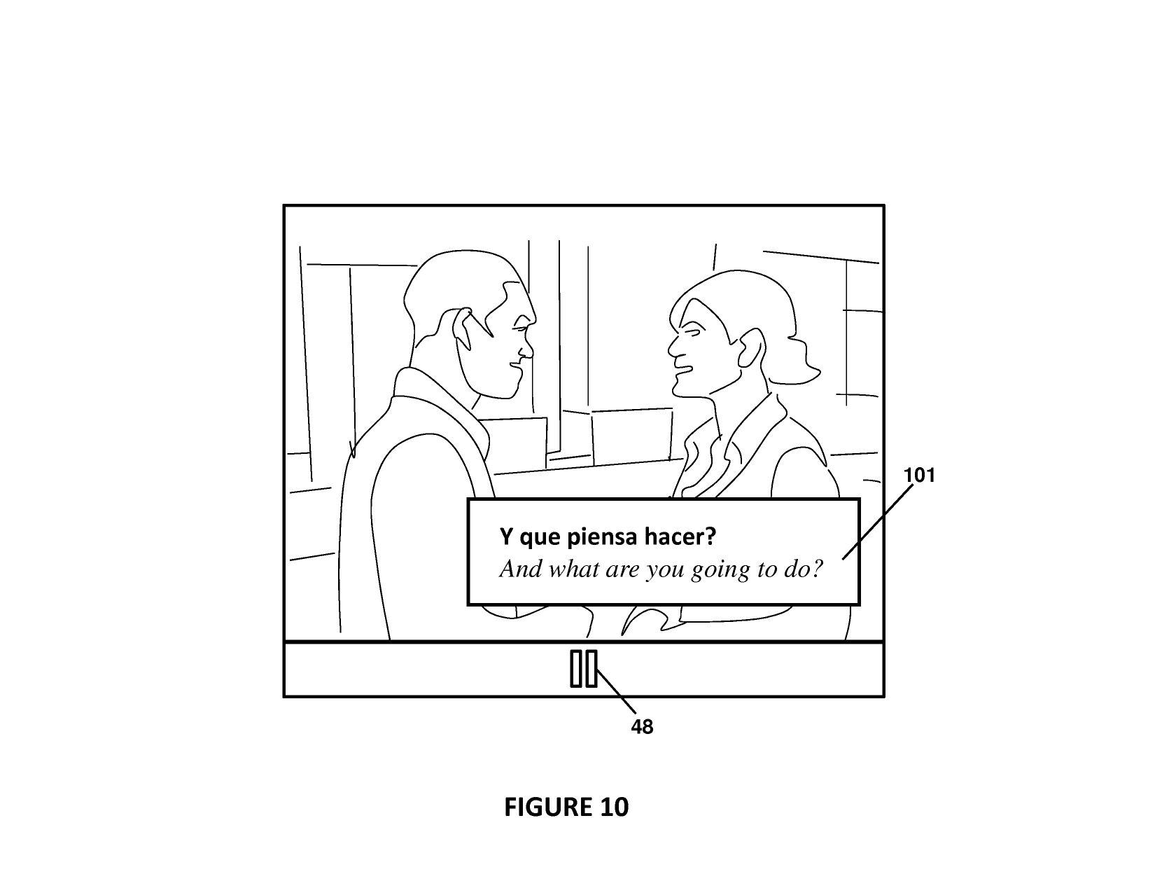

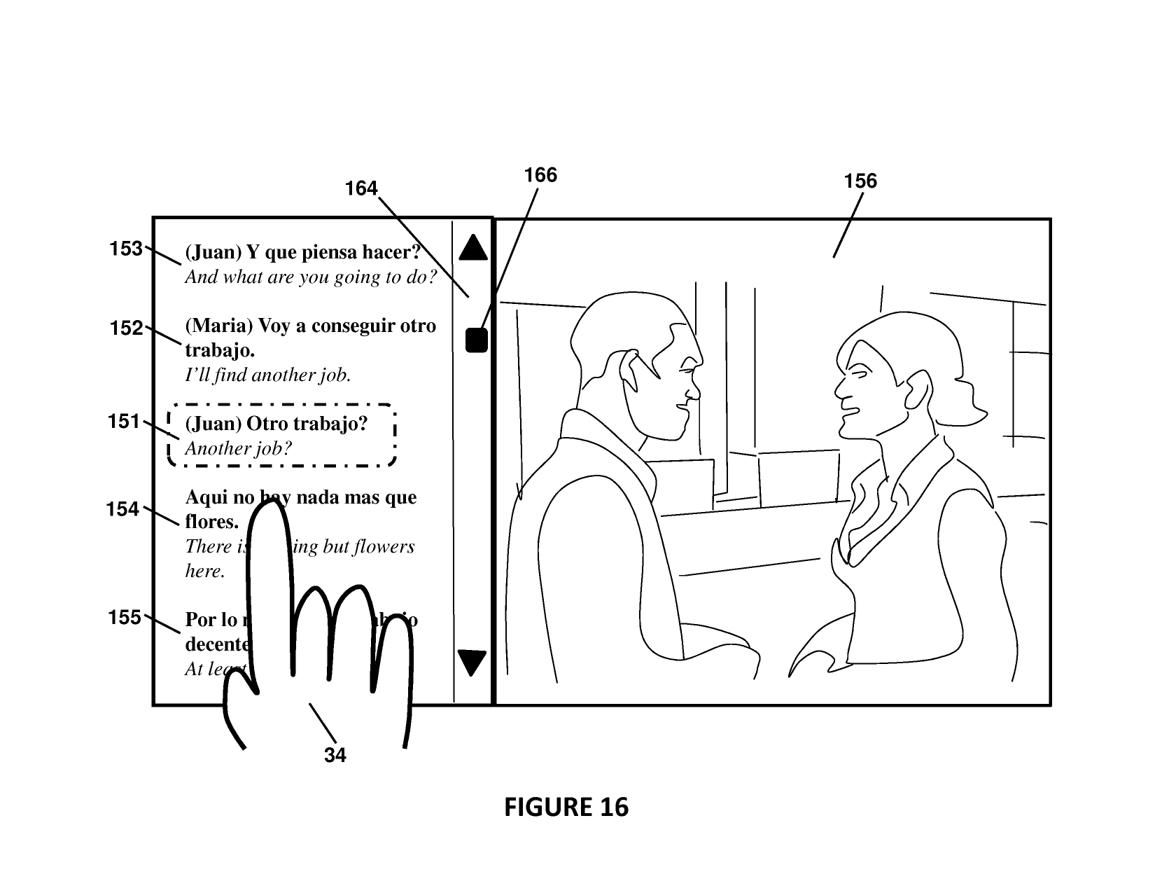

Screen shots may lead to a better understanding of the principles of the present invention. FIG. 10 provides an exemplary depiction of an image of AV content and a user control of an AVLD 40 when it is in Continuous Play mode system state 42 (see FIG. 4). Shown are a Pause control 48 and a text box 101. As noted there could be other user controls such as Fast Forward/Reverse or even a slide/progress bar illustrating the position of the depicted image in the AV content (for example see Slide/scroll control 164 in FIG. 16). The Pause control 48 causes a transition to the Stop-and-Go-mode system state 44 (see FIG. 4). As indicated there also might be a skip “Navigation” control that skips to a previous or subsequent learning segment while remaining in Continuous Play mode. In FIG. 10 the text box 101 presents a subtitle track that displays two subtitle tracks for the current segment, namely a Closed Caption and an English translation. Any number of simultaneous subtitle tracks from the meta data table 80 may be displayed on the screen per the user's preferences.

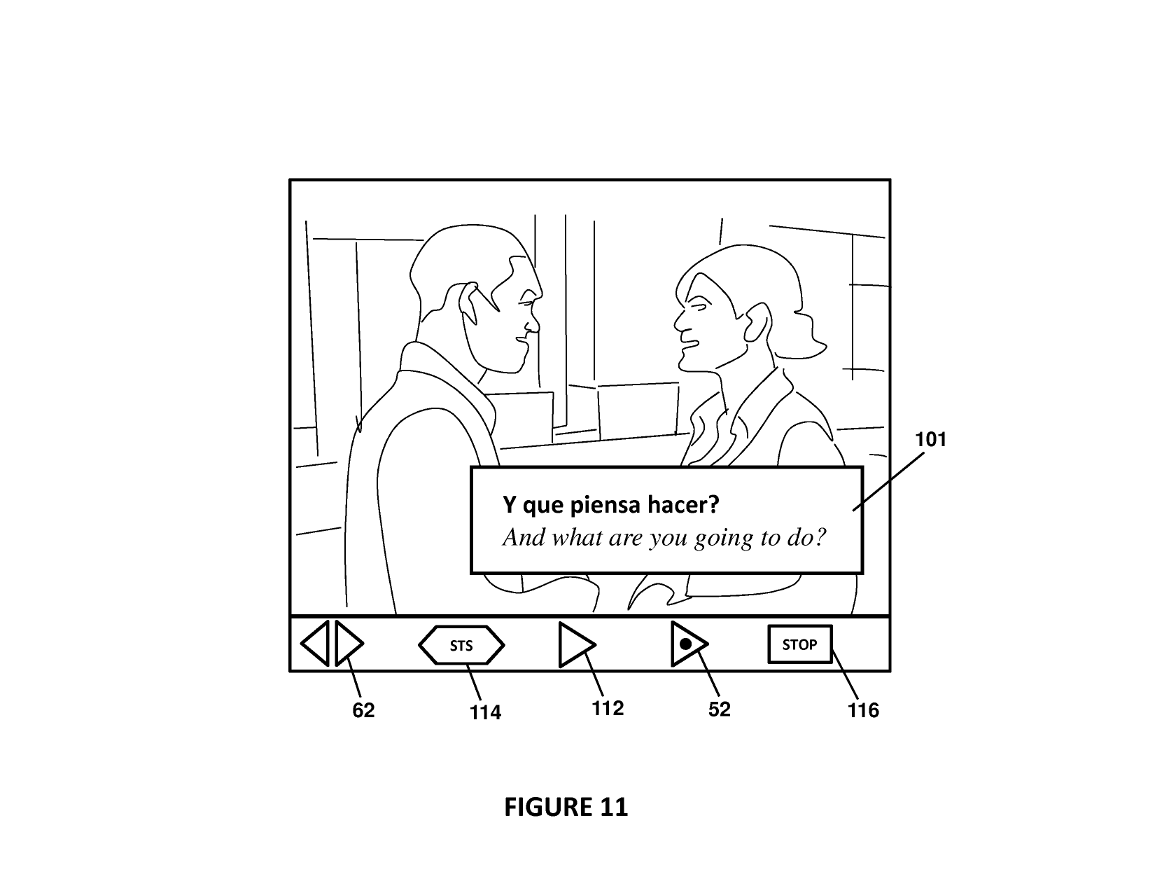

FIG. 11 provides an exemplary depiction of AV content and user controls of AVLD 40 when it is in the “Stop-and-Go” mode, SG1 system state 50 (see FIGS. 4-7). As illustrated and as previously described in SG1 system state 50, the start of segment n is presented (in a paused image) as AV content and a subtitle track is imaged in a text box 101. In SG1 system state 50 the Navigation/skip control 62 and the Play Segment control 52 are made available to the user 34. Additionally, a Continuous Play control 112 is made available to enable transition into Continuous Play mode system state 42 (see FIG. 4) and a Stop button 116 is available to stop the operation of the AVLD 40. Note that a Stop button 116 may be omitted in some embodiments. Furthermore, a Subtitle Select control 114 enables the user 34 to select one or more subtitle tracks.

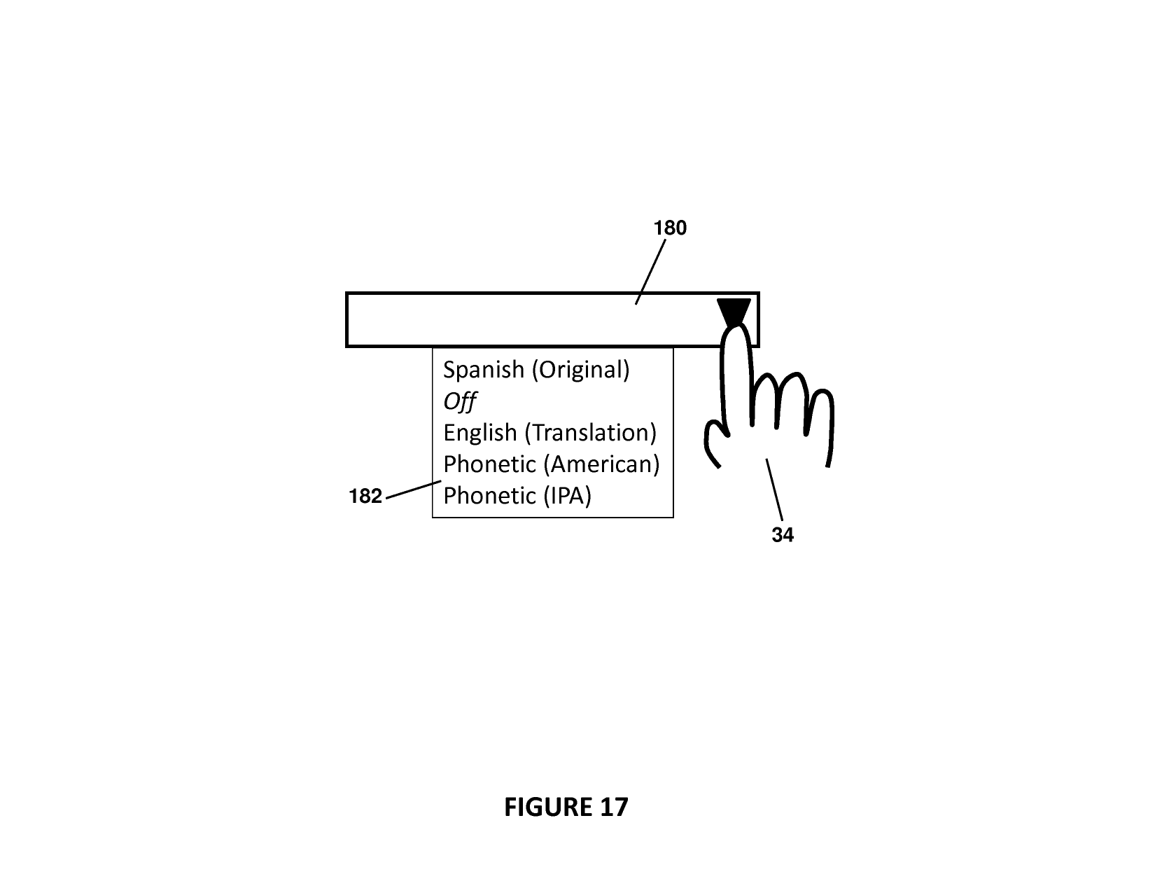

When activated the Subtitle Select control 114 presents a drop-down list of available subtitle tracks (see FIGS. 8 and 17). A person skilled in the art will understand that a drop-down list, or drop-down menu, is only one possible way of letting the user choose, or activate, one subtitle track or several subtitle tracks from a list of available tracks. Besides, a slide/progress bar as in state-of-the-art software video players may be available for fast navigation. Note that the user controls described and shown in the FIGS. 10, 11, 12 are only examples; a person skilled in the art will be able to rearrange controls on the screen in various ways, while materially achieving the same functionality.

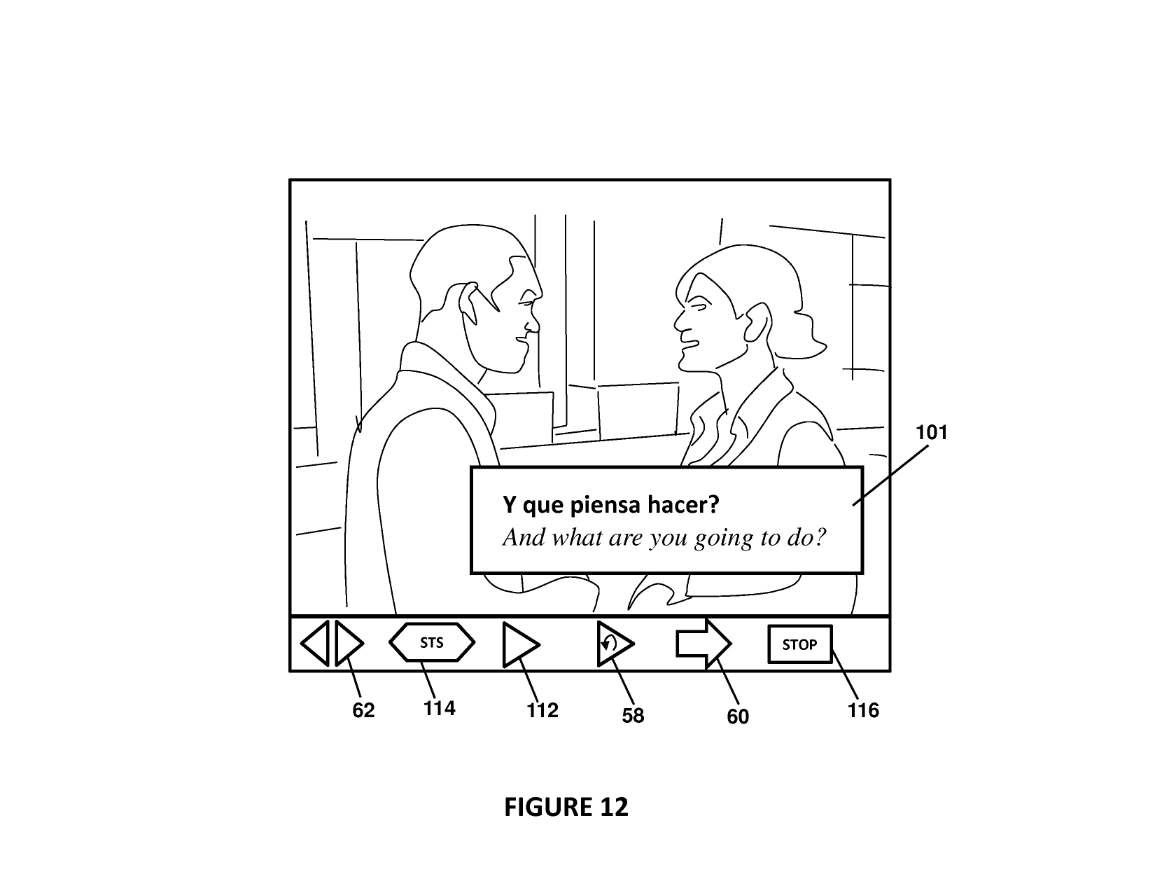

FIG. 12 provides an exemplary depiction of AV content and user controls of AVLD when in the “Stop-and-Go” mode of SG3 system state 56. As illustrated and as previously described the end of segment n is presented as AV content (in a paused image) and possibly a subtitle track are presented in text box 101. In SG3 system state 56 the Navigation/skip control 62, the Subtitle Select control 114, the Continuous Play control 112, and the Stop button 116 are also made available to the user. Furthermore, the Repeat Segment Control 58 and the Play Next Segment control 60 are made available.

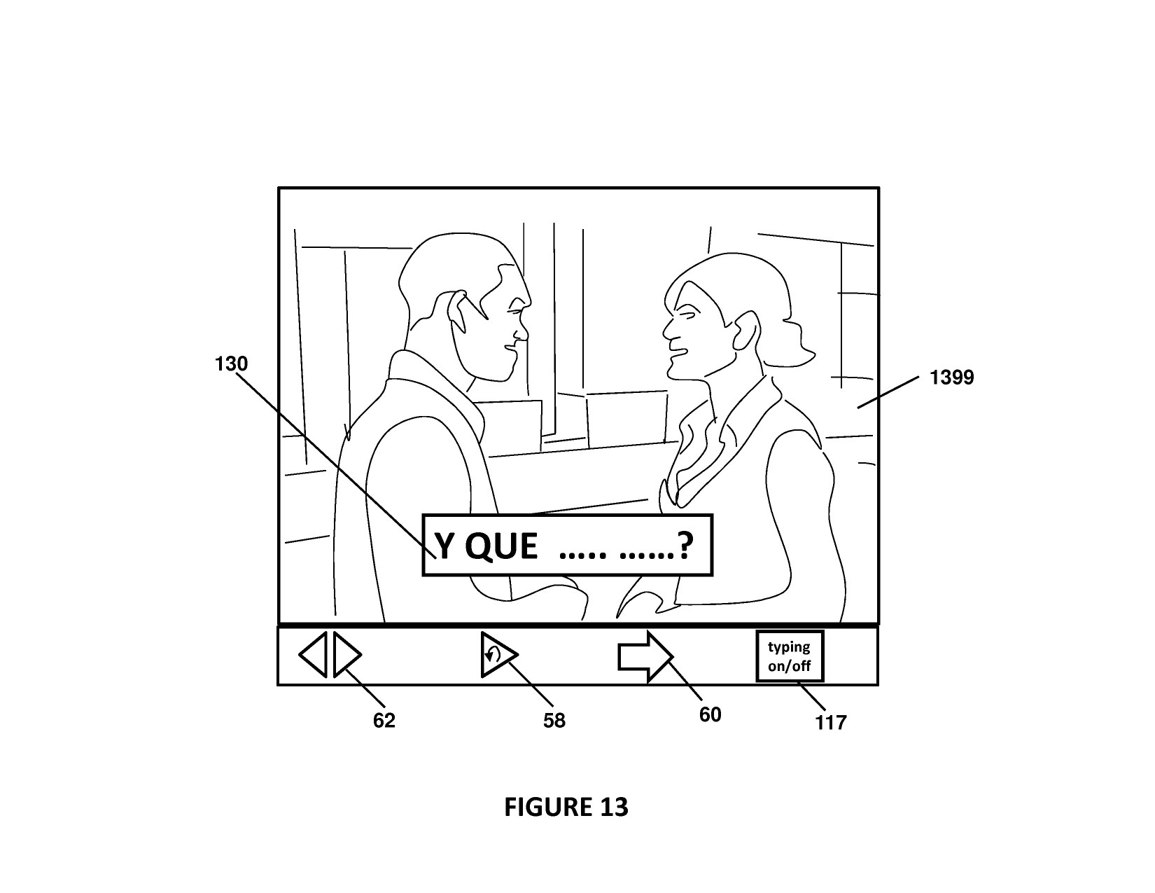

As described above the AVLD 40 includes a “Dictation” mode, reference SG4 system state 68 of FIG. 6. FIG. 13 depicts a screen shot of an AVLD in dictation mode when that AVLD 40 has a “hard” keyboard, such as keyboards 4 and 14 in FIG. 1. In that mode a text entry box 130 appears on a display. The text entry box 130 can appear in the same place as the subtitle box 101 or as an overlay to the video image 1399. In another embodiment, the text entry box 130 can appear next to the video image 1399, or on a remote or handheld 38 is illustrated in FIG. 3. FIG. 13 also shows a Typing control 117 that enables typing. When the Typing control 117 is on, as the user 34 types in information that information is displayed in the text entry box 130. Furthermore, the Navigation/skip control 62, the Repeat Segment Control 58 and the Play Next Segment control 60 are available (other controls can also be made available).

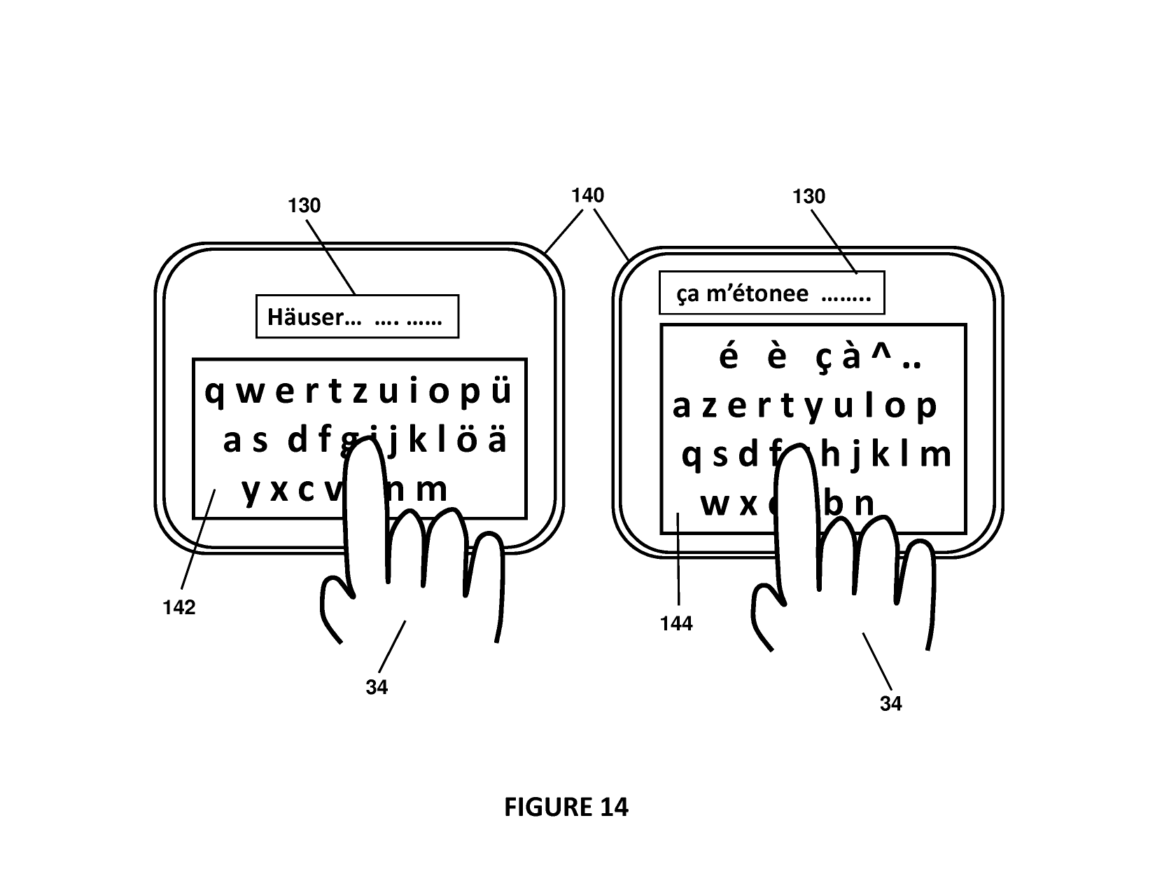

As noted above, in some ways “soft” keyboards, such as those on the tablet computer 30, reference FIG. 2, and the remote control 38, see FIG. 3 are preferable over “hard” keyboards. FIG. 14 depicts two examples of a tablet computer 140. In a first example the tablet computer 140 has a text entry box 130 and a “soft” keyboard 142 for enabling a user 34 to input a first language (say German). In the second example the tablet computer 140 uses a “soft” keyboard 144 for enabling the user 34 to input another language (say French). Another example is specialized keyboards to enter text for non-alphabetic languages, such as Chinese. The benefit of the tablet computer 140 is the ease with which soft keyboards can be changed.

A soft-keyboard is best used in connection with a touch screen, as the specialized keyboard layout can be directly accessed by typing on the special keys on the screen. However, even when a no-touch screen is available, keys on a soft keyboard can be accessed by using, for example, a mouse pointer on a conventional PC. In that latter case, it may also be possible to only display a small, partial soft-keyboard on the screen to choose from special characters, whereas the regular “hard” keyboard can be used to enter all other letters. Note that the soft-keyboard may be displayed on top, as an overlay to the Video image, in state SG3a. In the case where there is a remote input device 38 as in FIG. 3, the keyboard may only show up on device 38, not on the screen of the TV 35. In the case of a remote device 38, the text entry box 130, too, may appear on the remote controller but not necessarily on the screen of the TV 35.

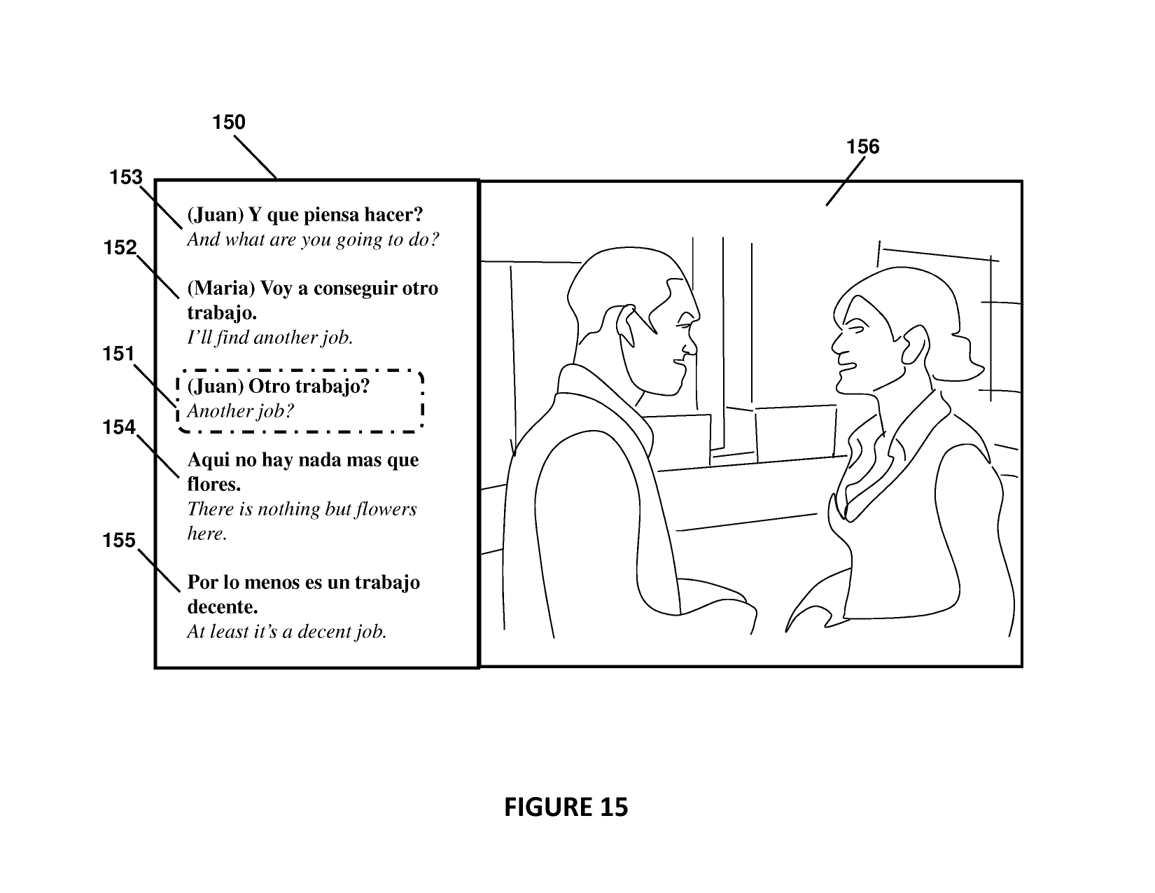

The use of meta data is highly advantageous in AVLDs. FIG. 8 provided examples of meta data segments 81, time stamps 82, subtitle tracks 83-87, and other meta data 88 and 89. Many other forms and presentations of meta data can be extremely useful for learning. FIG. 15 depicts context subtitles in a form that is similar to dialogues printed in books, such as plays and film scripts. Context subtitles can be useful not only for teaching the specific content of the learning segment n, but also for presenting a certain number of previous learning segments (n−1, n−2, . . . ) and subsequent learning segments (n+1, n+2, . . . ) in a form that provides the context for segment n. In FIG. 15, a subtitle 151 for segment n is displayed within a square (or otherwise highlighted using illumination, special color coding, or other visual aid) that will make segment n standout. Meta data for two previous learning segments, segment n−1 and segment n−2, are also presented as elements 152 and 153, respectively. Furthermore, meta data for two subsequent learning segments, segment n+1 and segment n+2, are presented as elements 154 and 155, respectively. While FIG. 15 shows the context subtitles as displayed outside of the AV content display area 156, the context subtitles could also overlay part of the AV content in the content display area 156. For example, on a small display screen the AV content might be shown and then after the content is complete and the AV content freezes the context subtitles can be shown as overlays.

Referring now to FIGS. 6 and 15, if an overlay is used, the overall context subtitle textbox 150 or some or all of the previous and subsequent segment subtitles may be disabled during the segment playback in SG2 system state 54. The full context subtitle textbox 150 in that case will reappear when the playback is paused in SG1 or SG3 systems states 54 and 56, respectively. Any number of previous and/or subsequent segments displayed in the context subtitle textbox 150 is conceivable; the actual number chosen will depend on the user's preferences and the screen area available to accommodate 150.

Another benefit of using a touch screen and context subtitles (see tablet computer 30, FIG. 2, remote control 38, FIG. 3, and FIG. 15) is that a touch screen can be used for navigation. For example, FIG. 16 illustrates a user 34 tapping subtitle 154. This causes the displayed segment to advance to segment n+1 (154 in FIG. 16). Such takes the place of a navigation control in other embodiments or the use of a mouse and mouse clicks in other embodiments. Of course if the user 34 had tapped context subtitle n−2 the displayed segment would have returned to segment n−2 (element 153 in FIG. 16). Likewise, by tapping the current segment n (element 151 in FIG. 16) segment n would have repeated. The foregoing has described tapping on context subtitles on a touch screen to induce direct navigation. It would also be possible to use mouse clicks on a computer, such as computers 2 and 12 in FIG. 1, which do not have touch screens.

In one preferred embodiment, clicking or tapping on a given previous or subsequent segment subtitle such as 152, 153, 154, 155, in the context subtitle textbox 150, will make the textbox 150 scroll the selected segment so that it is moved to the center of the textbox 150. The selected segment becomes the new current segment n, being displayed with special highlighting and thereby replacing what used to be segment subtitle 151. The previous and subsequent segments displayed are adjusted accordingly so that some new segments might become visible while others disappear. In one preferred embodiment, after selecting a new current segment 151 the system transitions to SG1 system state 50, showing the still video image representing the beginning of the new segment and allowing immediate segment playback of that segment. In yet another embodiment clicking or tapping, or double clicking or double tapping on a specific segment subtitle in the context subtitle textbox automatically transitions the AVLD into SG2 system state 54 to play back the chosen segment.

Larger scale navigation can also be accomplished using context subtitles, especially when using touch screens. Either or both a slide/scrolling control (as used in many programs such as Microsoft Word and on web sites) or a swipe control (as used on the Apple iPhone) can be used for rapid navigation. For example, still referring to FIG. 16, a Slide control 164 can be added to the AVLD. By a user 34 setting a finger (or mouse pointer or stylus pen) on the Slide control 164 and by moving the “Slide” control pointer 166 up or down, new subtitle segments can be brought into view in the area on the left of the Slide control 164. Then, once a desired subtitle segment shows up, tapping on it (single-tap or double tap) selects the desired new learning segment. The use of the Slide control 164 (or swipe control) provides additional orientation and enables fast movement across the overall AV content and meta data. It should further be noted that in a preferred embodiment that context subtitles with all or some of the playback controls, navigation controls, and possibly other user inputs such as keyboard typing or microphone input, can be provided on a remote (handheld) device 38 as shown on FIG. 3, while the AV content may be displayed on a larger screen 37 by the TV device 36. Alternatively AV Content and context subtitles and all controls can be provided on the same device, such as the touch screen table computer 30 from FIG. 2.

Another embodiment uses a “Swipe” control. In “Swiping”, the finger of the user 34 (or mouse pointer) is put on a specific location on the screen inside the context subtitle textbox 150 and then dragged to another (vertical) position in the textbox 150 and the finger or mouse pointer is released. The displayed subtitles move by the same amount, thereby making some subtitles shown previously disappear and others appear while moving a new set of context subtitles into the context subtitle textbox 150. Swipe controlling can be used for more localized navigation around the current segment n, while Slide control—or repeated use of a swipe control—can be used for larger scale navigation. Both can be used jointly. Note that the Slide control bar 164 can also be arranged horizontally as in state-of-the-art video player applications.

In the preceding description the current segment n (here: subtitle 151) will typically be in the vertical center of the context subtitle textbox 150 where it is made especially visible by its position and possible extra highlighting. In another embodiment, context subtitles may be more similar to an “electronic book reader” (e-reader) device. Instead of scrolling the content of the textbox 150 to always center the current segment as subtitle 151, the textual content of the textbox 150 would be static while segments are played back. Once the last segment on a given page was played back, the page turns to a new page displaying a new set of subtitles. At any given time, the subtitle representing the currently playing segment could be highlighted on the screen by showing a box around it, using a different font or color or other highlighting technique, one after another. In some applications it might be beneficial to “synch” AV content and meta data together. For example, to improve navigation in relation to context subtitles or standard subtitles, if learning segment 589 corresponds to the 23^{rd} scene in the AV content and it is the 78^{th} sentence of that scene when segment 589 is selected “Scene 23, Sent 78” or some equivalent information could be displayed. This could be stored in a meta table in column 89, see FIG. 8.

As previously noted the AVLD 40 can have selectable subtitle tracks. FIG. 17 illustrates one way to implement choosing a desired subtitle track. A user 34 touches a control 180 (or uses a mouse pointer) which brings up a plurality of possible subtitles 182. The user 34 can then scroll as required to select a desired subtitle track by tapping (or moves a mouse pointer and clicks). For instance, the 1^{st} subtitle track might be the Original Language subtitle track of the spoken text; the 2^{nd} subtitle track might be used to turn subtitles off, the 3^{rd} subtitle track might be an English translation, the 4^{th} subtitle track might be a phonetic translation, and the 5^{th} subtitle track might be another phonetic translation. It should be understood that multiple subtitle tracks can be selected, and subsequently displayed on the screen at the same time. For instance, the closed caption subtitle as well as a phonetic subtitle could be displayed together. Or, additionally, a translation could be displayed in conjunction with the other two subtitles.

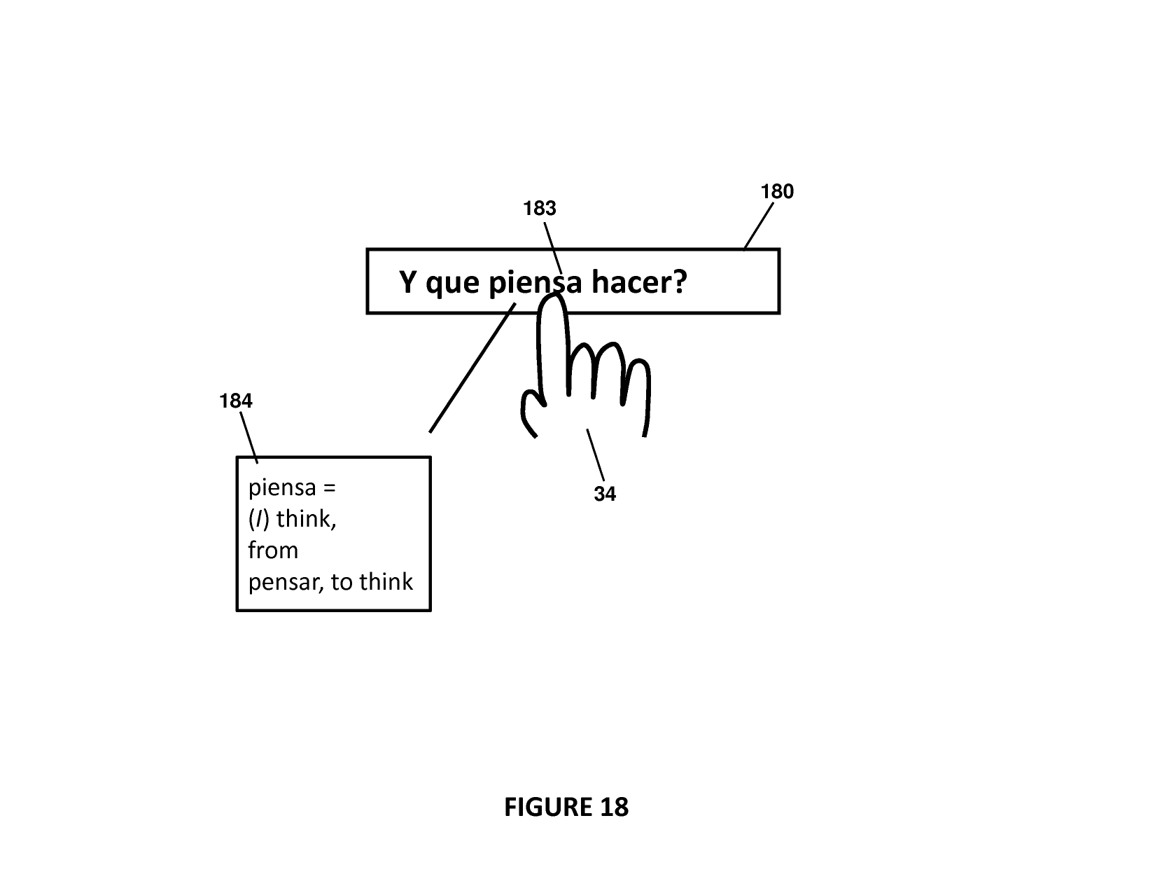

The AVLD 40 can be configured to provide rapid useful information. FIG. 18 illustrates a way of selecting a particular word for translation. A user 34 by tapping (or clicking) on a specific word 183 in a displayed subtitle track could bring up a text box 184 containing a definition of that word. This information can be stored as meta data, or there can be a link to an outside data source such as a specialized Website whose information is linked into the local display screen.

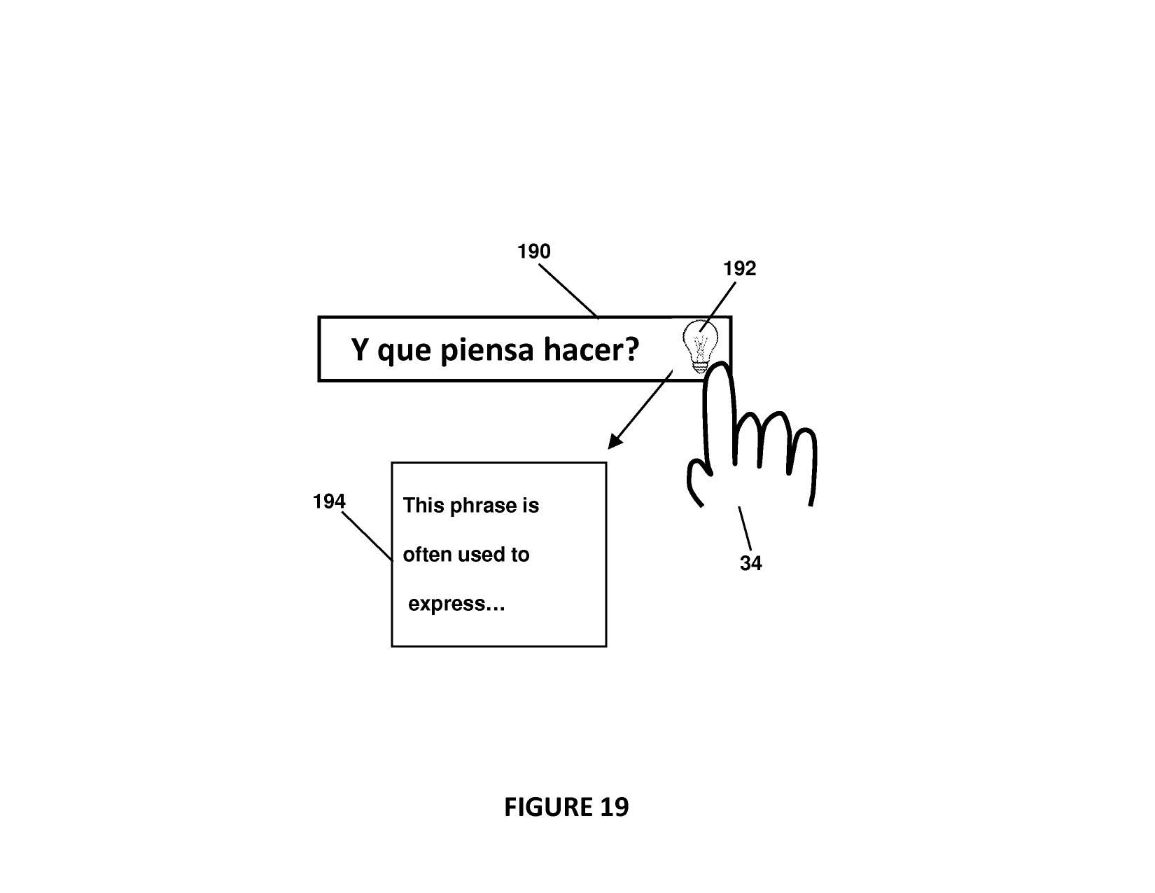

FIG. 19 illustrates a way of commanding additional explanatory meta data regarding the selected segment n. As illustrated, a text box 190 presents meta data regarding the current segment n. Additionally, the text box 190 includes a user Information control 192. By tapping the Information control 192 a user 34 causes (or by using a mouse pointer and clicking) an information text box 194 to pop up and display addition explanatory information about the current segment n.

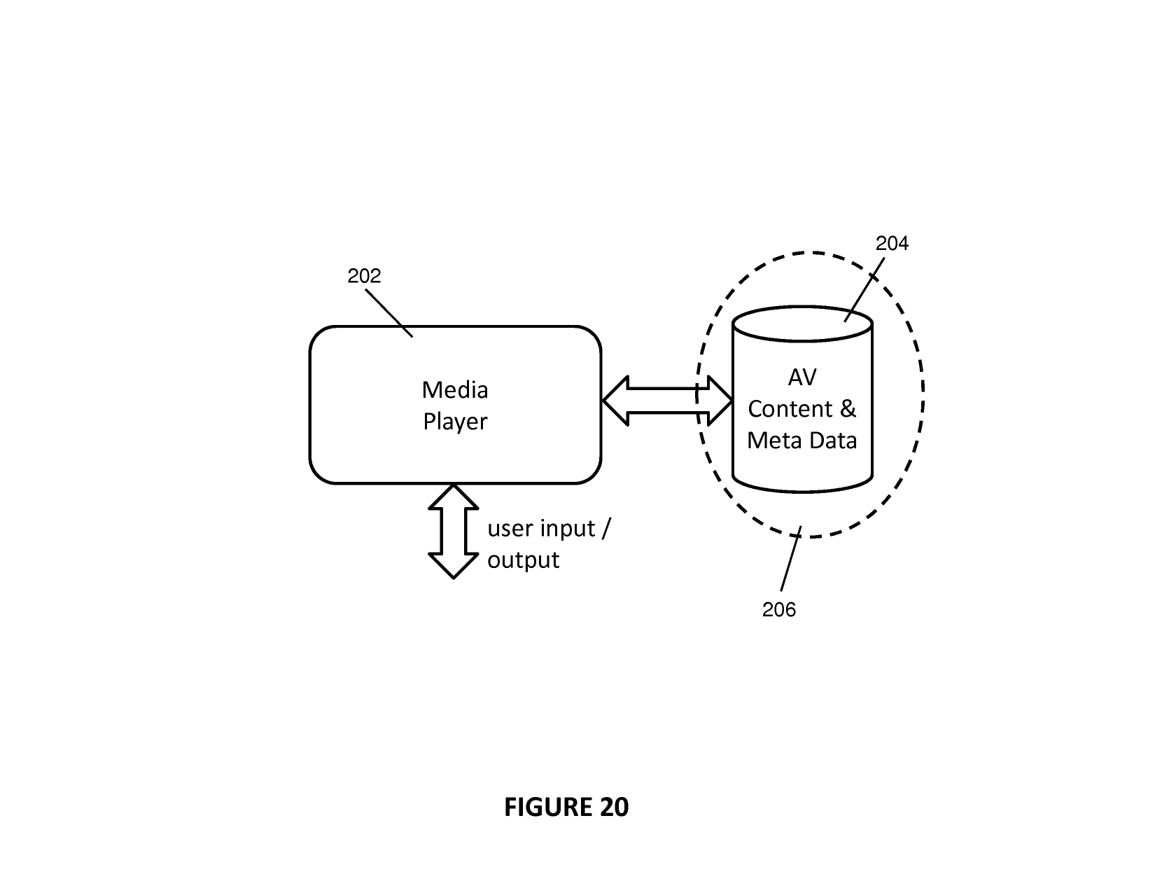

The AVLD 40 processes two general types of data: AV content in the form of learning segments and meta data. Referring to FIG. 20, in practice each AVLD 40 can be considered as being comprised of two sections, one being a specialized media player 202 with user controls that enable user input/output and a memory storage component 204. FIG. 20 illustrates a simple system in which the media player 202 interacts with one storage component 204 which contains all AV content as well as all meta data. In operation the Media Player 202 receives user commands and then requests information from the storage component 204 to produce visual and audio outputs. The component 204 might be a DVD, a local hard drive, a flash memory or even memory accessed over the Internet 206. Additionally, the component 204 might include program software for operating or remotely controlling the Media Player 202. Conversely, the Media Player 202 may operate or remotely control the component 204.

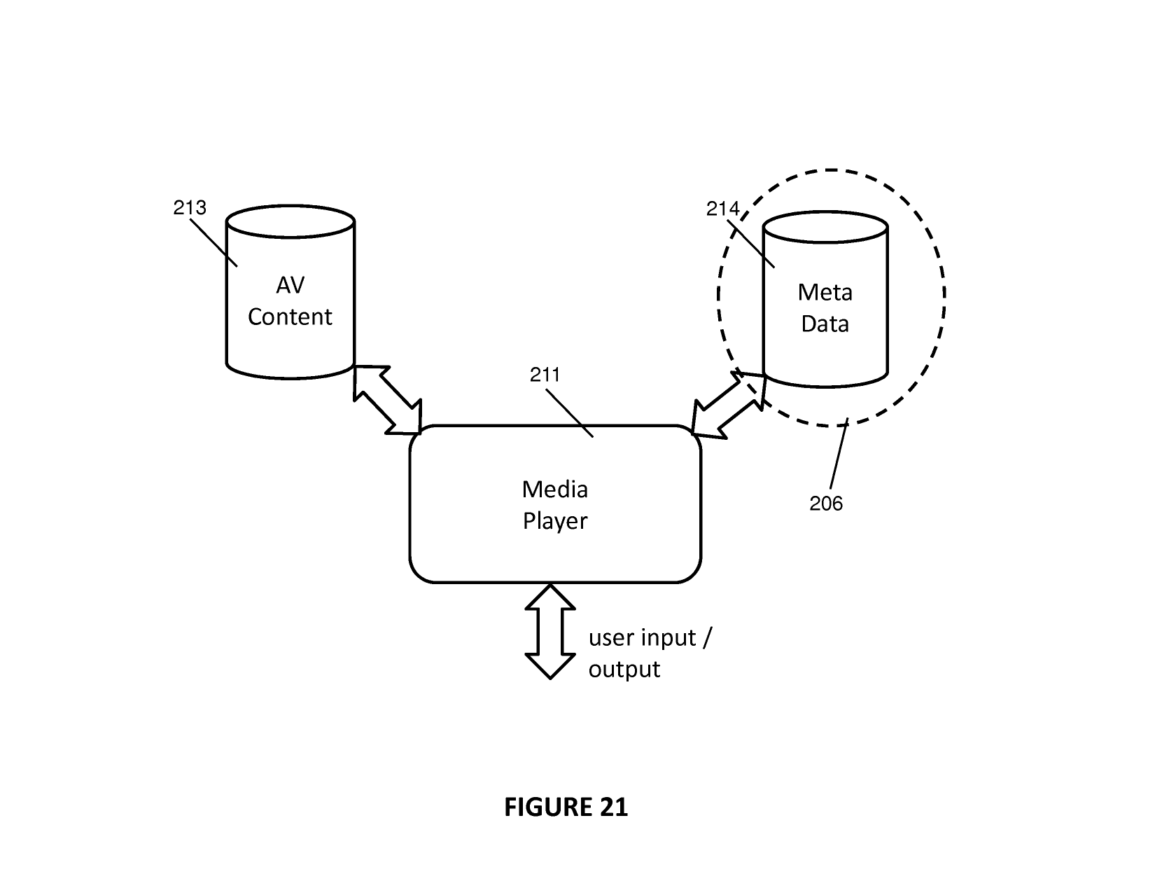

While FIG. 20 has one storage component 204, it is possible for the AV content and the meta data to be stored separately. For example, FIG. 21 illustrates a specialized media player 211 with user controls that enable user input/output, a first memory storage component 213 for storing AV content and a second memory storage component 214 for storing meta data content. The first and second storage components 213 and 214 can reside locally in a local hard drive, DVD, flash memory or they can be distributed over the internet. For example, in FIG. 21 the first memory storage component 213 is local while the second memory storage component 214 is accessed via the Internet 206. In operation the specialized media player 211 accesses time based information contained in the AV content while meta data is synchronized with the time base. That is, the player retrieves suitable pieces of information from the two memory storage components during playback and interaction with the user on a per-needed basis.

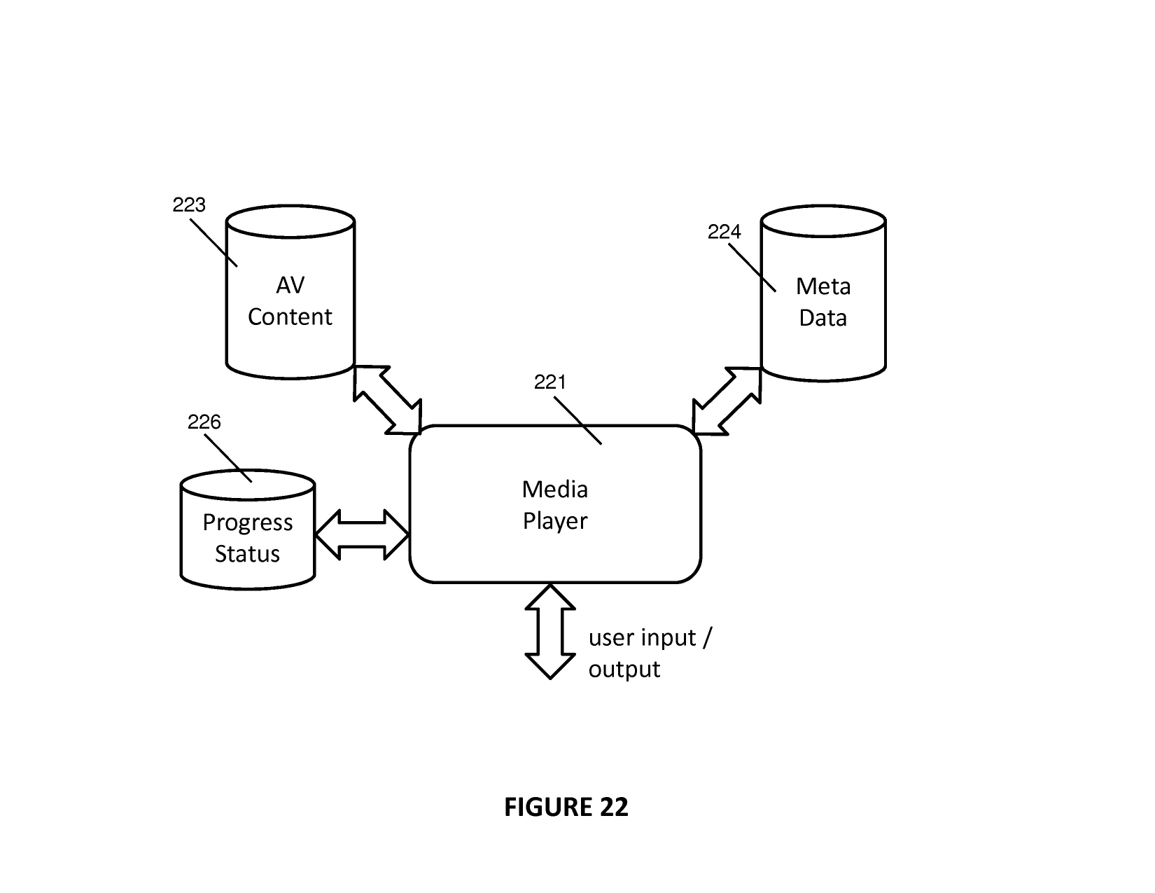

Other memory storage configurations are also possible. For example, FIG. 22 illustrates an AVLD having a specialized media player 221 with user controls that enable user input/output, a first memory storage component 223 for storing AV content, a second memory storage component 224 for storing meta content, and a third memory storage component 226 for storing auxiliary information such as the progress status of the user, text entries, user notes, and word study lists.

In many modern digital players AV content is stored in a digital format referred to as MPEG-4. Even if a particular AVLD uses AV content in a different format that format will usually be similar to MPEG-4. This is because MPEG-4 type digital formats compress data to a manageable size while still allowing high-enough quality AV content. Without compression the memory size of AV content could become so large that it would simply take too long for transmission to be useful.

Compressed video is usually comprised of three different types of frames: I-frames, P-frames, and B-frames. I-frames (or intra-frames) represent a video image when the video content is quasi-static. I-frames present a complete image at one particular time without temporal dependence on any previous or subsequent frames. I-frames can be thought of as a snapshot at a given time, like fully self-contained still images such as digital jpg images. P-frames, in contrast, are predictive frames in which only information relative to a previous video frame is stored and/or transmitted. So, an I-frame presents something of a snapshot at one time while the next P-frame contains only changes from the I-frame. The following P-frame contains only changes from the prior I-frame+the prior P-frame. B-frames typically contain small data changes that leverage temporal redundancy. B-frames make use of bidirectional “predictions” for previous and subsequent video frames. Oftentimes the overall screen image of a digital video stream may be subdivided into so-called macroblocks: square pieces of each image containing a certain number of image pixels, such as 16 times 16 pixels. The decision to use I-frame, P-frame, or B-frame encoding may be made separately for each macroblock in the state of the art.

Compression takes place by converting raw AV content into a sequence of I-frames and P-frames and/or B-frames. I-frames refresh the content at somewhat regular intervals, while P or B frames are used to interpolate between I-frames in order to reduce the amount of data needed to represent the video content.

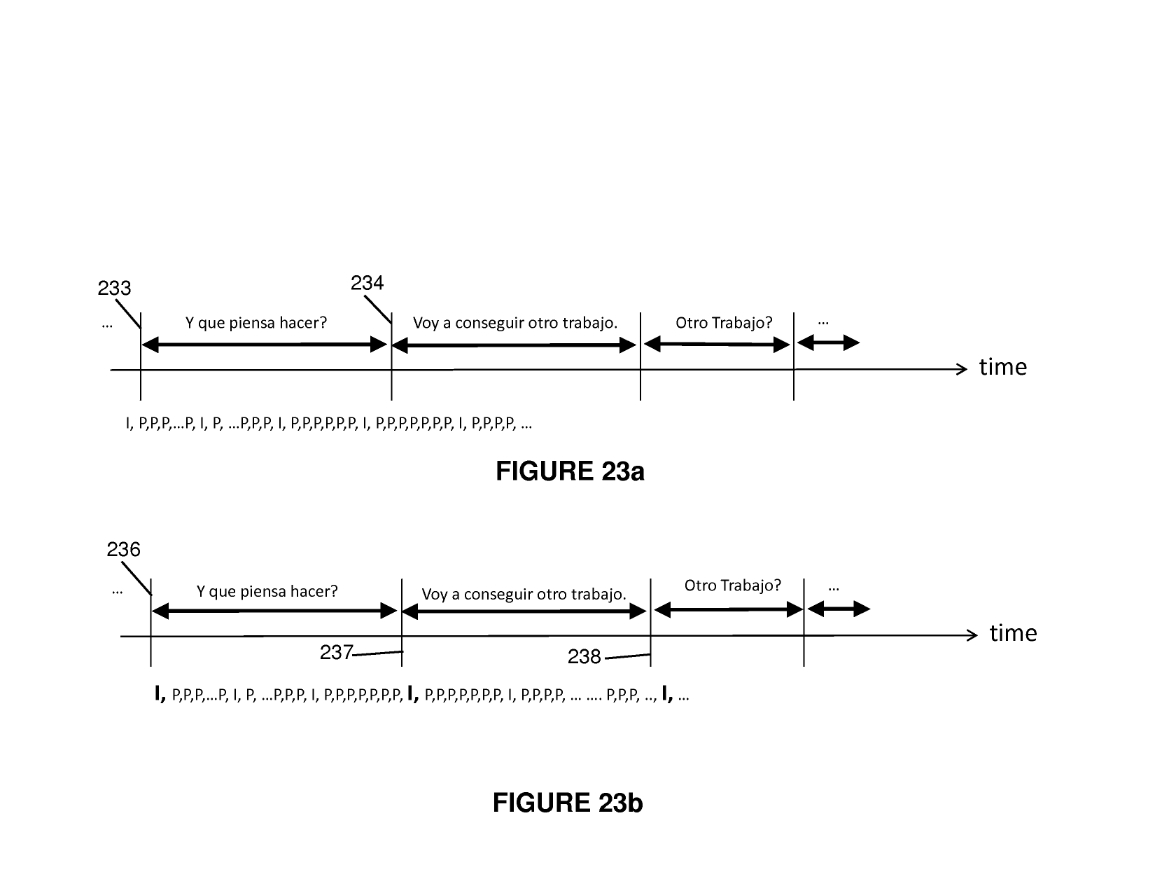

A consequence of the interleaving compression approach using I frames and P/B frames is that starting to play back conventional AV content is not possible at any arbitrary time. For instance, if playback is desired at a given time corresponding to the start time of a learning segment the video frame sequence may be in the middle of a sequence of P/B frames. Therefore, it will take some time into the playback to capture an I-frame and restore a good image quality. Otherwise video “tearing” occurs. Such tearing is a drawback of using conventionally encoded AV content in the context of an advanced language learning system as described in this invention. FIG. 23a illustrates the problem. A desired segment 233 might start on something besides an I-frame; the next segment 234 also might start on something besides an I-frame. The succession of I, P frames underneath the time axis is totally uncorrelated with the start of learning segments.

FIG. 23b illustrates how to overcome this problem. In FIG. 23b the AV content is preprocessed before use such that each learning segment starts on an I-frame. For example learning segment 236 starts on an I-frame as do learning segments 237 and 238, and so on. That way when an arbitrary learning segment is played back, in any arbitrary order, a good image quality can be established immediately, as the I-frame video content does not require a gradual build-up but occurs at the beginning of each learning segment.

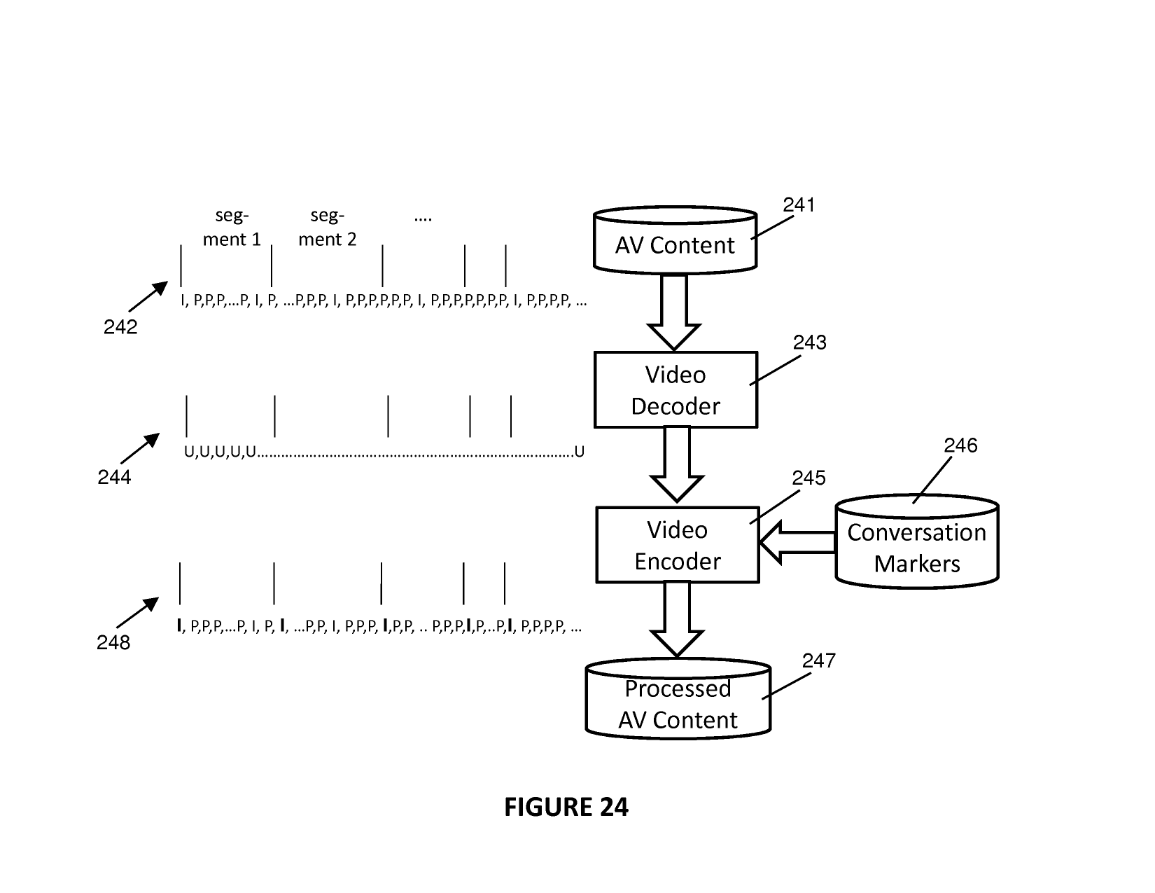

One method of obtaining learning segments synchronized with I-frames is illustrated in FIG. 24, which presents an off-line method of synchronizing AV content segments with I-frames. AV content 241, defined by a framing sequence 242, is applied to a video decoder 243 to obtain uncompressed data 244. The uncompressed data 244 is then applied to a video encoder 245. The video encoder 245 also receives conversion markers 246. The conversion markers 246 are identifiers for the various learning segment start times and are supplied by an editor (learning instructor). The video encoder 245 processes the uncompressed data 244 and the conversion markers 246 to synchronize the start of I-frames to produce processed AV content 247 containing properly synchronized framing sequences 248. If a macroblock based video representation is used, at the beginning of a segment, all macroblocks representing the overall image will be encoded as I-macroblocks.

When discussing various controls, input devices, and actions of AVLDs in accord with the principles of the present invention, reference FIGS. 3, 4, 5, 6, 7, 10, 11, 12, 13, and 14, the discussions primarily focused on using touch controls, mouse controls, and textual entry of information via keyboards and touch screen. However, the present invention encompasses other methods of information entry and control, specifically including acoustic-based controls and data entry. For example, a user could be prompted to speak into a microphone and the user's pronunciation could then be verified using voice recognition. Continuing with acoustic-based operation, if the pronunciation was deemed sufficiently correct an automatic transition could be made to play the next segment in the segment sequence. Likewise, voice recognition software could be used to implement operating controls, such as by voice recognizing commands such as “Repeat,” “Play,” “Pause,” “Stop,” “English,” “Phonetic,” “Translate,” “Skip,” and then acting accordingly.

The foregoing discussions also tend to infer that the segment length is not adjustable. However, some embodiments of the present invention will have an adjustable segment length. In such cases a user control will be included to enable changing the typical length of a segment. For instance, the default segment length could be one phrase, expression, or sentence. Upon user request, or after the material being learned has been mastered to some degree multiple consecutive segments can be joined to form a super-segment. All controls discussed so far would then apply not to each individual segment, but to super-segments. The Meta Info table 80 illustrated in FIG. 8 might contain “group markings” such as SS1 (super-segment 1) and SS2 (super-segment 2) as part of the “Other info” column 89 to indicate which segments will be grouped together to form super-segments.

In another embodiment, playback in Continuous Mode or Stop-and-Go mode will allow speed control. If the spoken speed in a given segment is too fast, the user could reduce the playback speed. In a preferred embodiment, the speed adjustment will also utilize pitch preservation. Such techniques are well known in the prior art. If a given audio content is simply played back more slowly, the pitch will go down proportionally. State-of-the-Art pitch preservation technology can be used to change the speed while maintaining the pitch of the spoken audio content, thereby avoiding distortion of voices.

In yet another embodiment, the voice of the user can be recorded when he/she recites a given segment by reading the corresponding subtitle. That recorder vocal information can then be matched and paired with the video content for later playback. Such playback may be beneficial to compare one's own voice in another language with that of the original audio track in the audio-visual content. That way, the user may adopt the role of the voice of one of the characters in the audio-visual content.

It should be emphasized again that in the preferred configuration embodiment shown on FIG. 3 that the remote control device 38 (such as a touch screen phone or tablet computer) may be used to enter text with a touch screen keyboard, to display subtitles including context subtitles, or user controls for playback, repeat, or navigation. The TV screen 35 may only be used for displaying the audio-visual content. In case of context subtitles being displayed on the remote device 38, the TV 35 may still display the selected subtitle tracks covering only the currently playing segment. Note that in a preferred embodiment, device 38 will have an audio headset (for listening) and microphone (for speaking and recording) connected to it. A typical scenario will be a headset containing both ear-phones as well as a microphone.

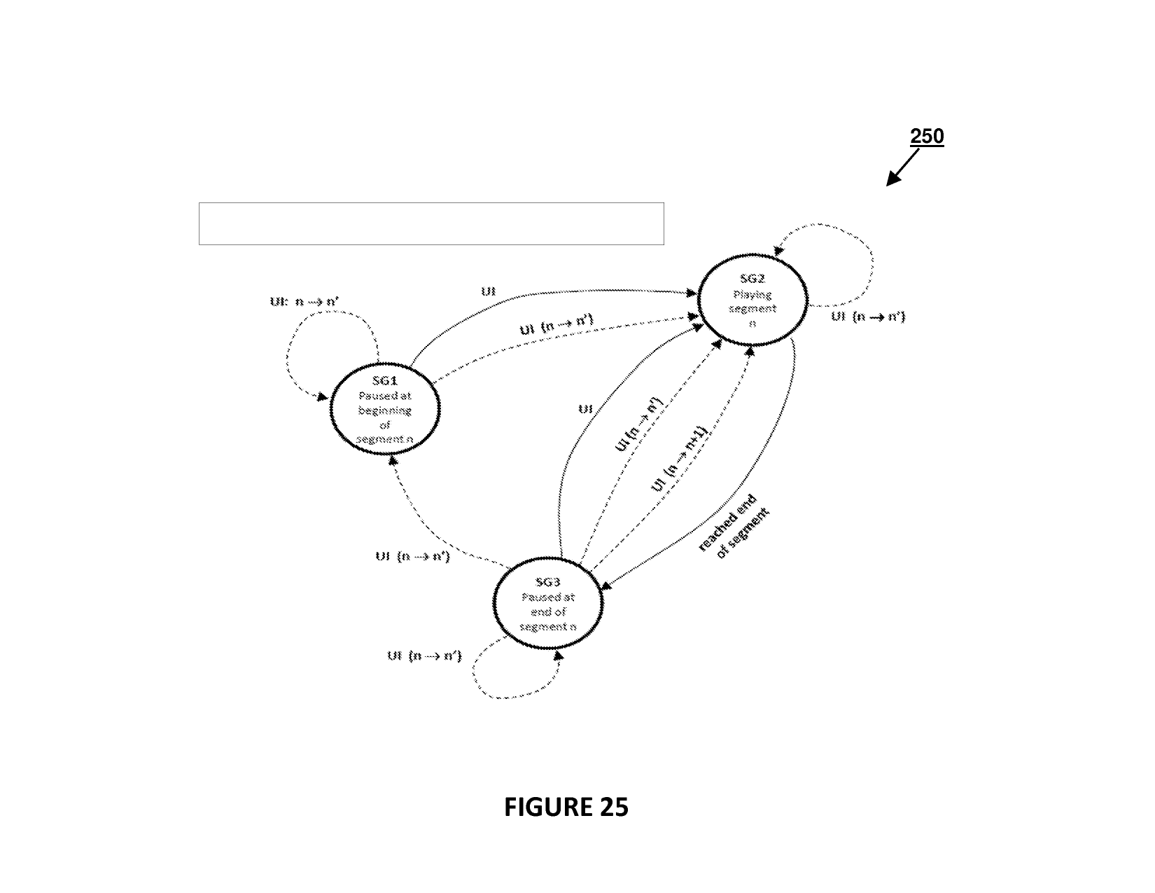

The foregoing operational descriptions of AVLDs can be viewed as embodiments of a generic AVLD 250 illustrated in FIG. 25. In FIG. 25 “UI” stands for User Input, which generically refers to any form of user input such as activating a button, clicking a mouse, or tapping on a subtitle. The dashed lines are optional and represent UI for navigation purposes (skipping to a previous or subsequent segment); e.g., such a UI could be tapping a finger on a subtitle in the “Context Subtitles”. FIG. 25 illustrates how UI's are used to request play/repeat/navigation, while the system automatically stops at the respective next “conversation marker.” The various state transition arrows are general enough to be associated with various embodiments, such as specific buttons or advanced forms of user control through tapping/clicking on Context Subtitles.

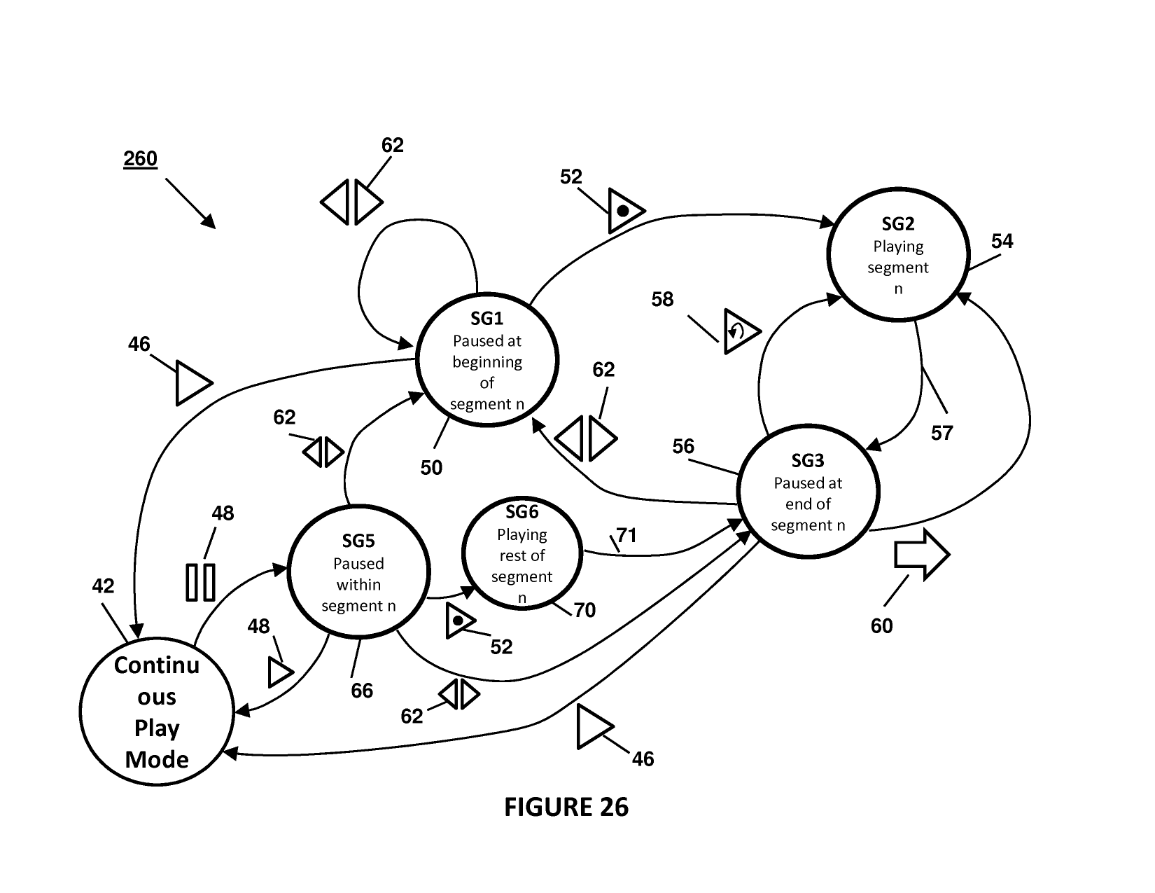

Finally, it will be understood by those skilled in the art that the transition from Continuous Play mode system state 42 to Stop-and-Go-mode system state 44 or vice versa (as shown in FIG. 4) may happen at any time. This is illustrated in a more detailed flow diagram 260 in FIG. 26, by adopting a transition state “Paused within segment n”, SG5 system state 66. It will be easily understood by someone skilled in the art that the above controls in Stop-and-Go-Mode (such as playback, skip and navigation controls 52, 58, 60, 62) may temporarily have a slightly modified meanings when used in SG5 system state 66, compared to the ones shown on FIG. 5.

For instance, when the system is in Continuous Play mode system state 42 and is subsequently paused by the user via activation of Pause control 48 in the middle of the current segment n (“within” segment n, that is somewhere between beginning and end), playback will stop with the Video image being held on the screen that was in display in the very moment the Pause control 48 was activated. Once halted in this state, namely SG5 system state 66, the following functionality will beneficially be linked to the user controls in Stop-and-Go-mode: A first activation of a Navigation/skip control 62 may jump to the beginning, or end, of current segment n, as opposed to skipping to a previous segment n−1 or subsequent segment n+1. This will cause transitions to SG1 system state 50 or SG3 system state 56, depending on the direction of the navigation/skip control activated by the user.

Still referring to FIG. 26, the Play Segment control 52 (or the Play Next Segment control 60) will cause playback of the remaining portion (rest) of segment n until the end of segment n is reached in SG6 system state 70. Upon that, via automatic transition 71, the system goes into paused state again, holding playback in SG3 system state 56. Also, the Repeat control 58, when activated after the playback was paused in the middle of a segment n, will beneficially start playback at the beginning of segment n and stop playback at the end of segment n: The system will transition from SG5 system state 66 to SG2 system state 54 upon activation of Repeat control 58 (not shown in FIG. 26), there play back the full segment n, and then automatically pause in SG3 system state 56 via transition 57 again.

SG1 system state 50, SG2 system state 54, SG3 system state 56 (or SG3a system state 59 and SG4 system state 68 if dictation mode is enabled), SG5 system state 66, and SG6 system state 70 in their entirety represent the Stop-and-Go-mode system state 44. It should be understood that transition from Stop-and-Go-mode system state 44 to Continuous-Play-mode system state 42 can happen at any time by activation of Continuous Play control 46. In that event, a transition will occur from the currently active Stop-and-Go-mode state SG1 system state 50, SG2 system state 54, SG3 system state 56 (or SG3a system state 59 and SG4 system state 68 if dictation mode is enabled), SG5 system state 66, or SG6 system state 70, back to Continuous-Play-mode state 44. (Those transitions back into Continuous-Play-mode state 44 are not shown in FIG. 26.)

The concept of overlapping learning segments is highly beneficial. In the embodiment shown in FIG. 8 there is one timestamp 82 per segment and the durations of segments are defined by subsequent timestamps. For instance, segment 569 in FIG. 8 extends from its timestamp 1 h 27 m 11.1 s in column 82 to the time-stamp of the subsequent segment 570, which is 1 h 27 m 12.2 seconds. This concept of contiguous (non-overlapping) segments can be generalized using the embodiments illustrated in FIGS. 27 and 28. Those figures introduce the concept of overlapping but still ordered segments and the technology related to such ordered overlapping segments.

FIG. 27 illustrates a portion 270 of audio-visual content over the time axis 2740. The temporal extent of the portion 270 spans the time from a time instant 2705 to a time instant 2716. The portion 270 has four segments, 2730, 2731, 2732, and 2733. Each of those segments corresponds to a spoken sentence in the portion 270. The sentences can be illustrated as being part of dialogs DA 2701, namely segments 2730 and 2732 that are spoken by speaker “A” while dialog portion DB 2702, namely, segments 2731 and 2733 are spoken by speaker “B”.

Dialogs DA 2701 and DB 2702 partially overlap. For example, segment 2730 starts at time 2705 and ends at time 2706 but does not overlap with anything said by speaker B. However, speaker B speaking segment 2731 does not end before speaker A starts speaking segment 2732. They overlap. In segment 2731 speaker B says “Y que piensa hacer?” from time 2706 to time 2710 Meanwhile speaker A says “Voy a conseguir otro trabajo” between time 2708 to 2709. There is an overlap 2741 between time 2708 and time 2710. Other overlaps occur, such as 2742.

Such overlaps are part of normal speaking and someone learning a language must deal with such overlaps. Yet a learner nonetheless still wants to make use of meta data of a sentence without the overlap. Therefore, defining learning segments that deal with overlapping speakers is beneficial to improving the user experience and learning success. For instance, if segments 2731 and 2732 were defined as non-overlapping abrupt and unnatural dialogs having missing content would result.

When using overlapping segments the meta information table 80 such as shown in FIG. 8 will not only contain a column 82 with the time-stamp for when a learning segment begins, but also a column with the time-stamp for when the segment ends. In Stop-and-Go Mode 44, playing segments one segment at a time will follow these dual time-stamps. Note though that in Continuous Play mode 42 overlaps will be ignored and the AV content will play back as a continuous stream.

A refinement for playback of overlapping segments is illustrated in the bottom half of FIG. 27. Diagrams 2703 represents an exemplary playback parameter P used by the AVLD when playing back each learning segments. Playback parameter P may be volume or video image intensity such as the image brightness, color saturation, or contrast, or another suitable playback parameter. To enhance the user experience, the playback parameter P can be changed over time during the overlap periods, such as the overlaps 2741 or 2742. For instance, if segment 2731 is played back in Stop-and-Go mode the playback stops abruptly at time 2710. To avoid unpleasant audio and video cutoff or “freeze” effect if the segment 2732 started immediately at time 2708 the playback parameter P of segment 2732 starts earlier and ramps up 2713 to normal at time 2708. Further, rather than abruptly stopping such as at time 2709 the playback parameter P ramps down (tapers off) at time 2709. This smoothes out the content while playing the learning segment 2732.

FIG. 28 shows ramp down in more detail using a segment 2801. The main content of segment 2801 extends from time 2804 to time 2805. During this time playback parameter P is kept at a constant level 2807. Segment 2801 also includes the time interval between times 2805 and 2806. During that time interval the playback parameter(s) P is ramped-down 2803 from level 2807 to 2808. Those skilled in the art will recognize that the ramp-down or ramp-up of the playback parameter P may not necessarily be happening at a constant slope over time. Ramp-up or ramp-down could take place piece-wise as a “stair-case” shaped increase or decrease 2809 using steps such as 2810, 2811. The staircase implementation is probably more practical. Also the level P 2807, the effective slope of the ramp 2803, (or the extra duration 2805 to 2806), the number of steps 2810, 2811 in a stair-case implementation 2809, or the final level of the ramp-down 2803 can be configurable to best fit the particular application.

The ramp-up and/or ramp-down control is beneficially contained in the meta data table 80. In a straightforward practical implementation, the table 80 will contain a column containing yes/no information describing whether the segment contains a ramp-up interval, and another column containing yes/no information describing whether the segment contains a ramp-down interval. The exact definition of the ramp-down configurations, such as duration and start/stop levels of the playback parameter P, can then happen elsewhere in the AVLD and will thus apply to all learning segments. It should finally be noted that above ramp up or ramp down mechanisms can be used in conjunction with other segments, with or without overlap.

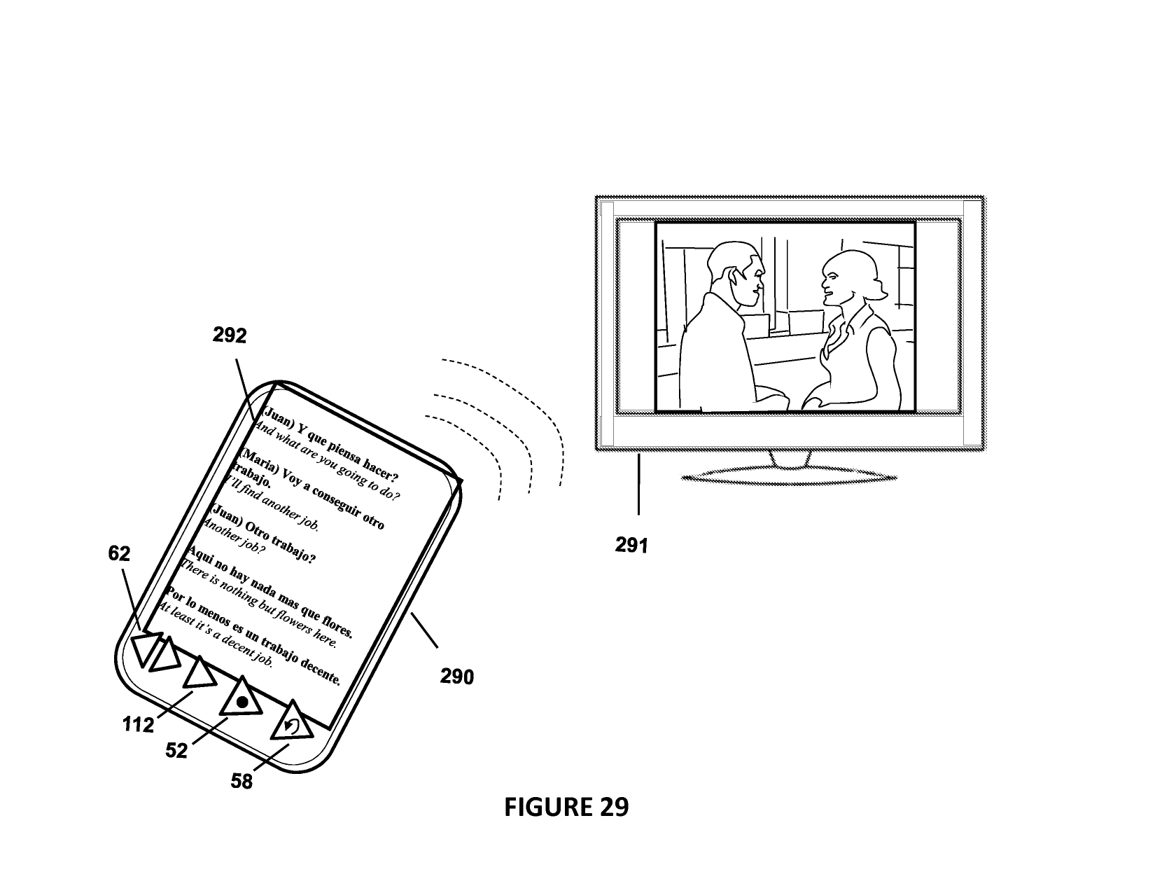

FIG. 29 shows a usage scenario similar to shown in FIG. 3. In FIG. 3, the handheld device 38 is used to type in information in a dictation mode. In the embodiment shown in FIG. 29 the handheld device 290 uses a textbox 150 as in FIG. 15. That textbox 150 and its context subtitles, specialized user controls such as controls 62, 112, 52, and 58, and/or navigation by the user 34 by means of subtitle windows as illustrated in FIG. 16, all take place on the handheld device 290. The video data and/or audio signal are reproduced by the TV or computer screen 36. The handheld device 290 also implements the typing capabilities of the handheld 38 along with the subtitle and navigation capabilities.

It is beneficial to distinguish the operating mode (dictation versus subtitle based navigation) by using the orientation of the handheld device 290: If the handheld device 290 is held horizontally it acts as a typing keyboard 39; if it is held vertically it acts a device for reading subtitles and implementing subtitle navigation.

In a beneficial modification of the system shown in FIGS. 21, the AV content 213 and/or meta data 214 (or joint AV Content & meta data 204 as in FIG. 20) are cached in the Media Player 211 (or 202 in FIG. 20). Caching refers to local storing of data as a copy of data at an original storage location. In one embodiment the media player 211, 202 will contain cached copies of the AV Content and/or meta data for the current segment n and a configurable number of segments before and after segment n. This allows low-latency playback of learning segments around the current segment n, as such surrounding segments are most likely to be selected by the student for subsequent playback.

At all times, if playback or navigation updates the current segment n to be a new segment n′, the caching mechanism will ensure that the desired number of segments before and after the new segment n′ will be cached locally in the media player 211, 202 by retrieving the corresponding AV Content & meta data from the containers 213, 214. This caching arrangement is particularly useful in a system configuration where the AV Content and/or the meta data reside on geographically remote storage systems that are accessible via a network such as the Internet while the Media Player 202, 211 is operational at the location of the student.

A particularly beneficial embodiment combines elements from FIGS. 11, 12, 15 and 16. It provides a student with a combination of specialized user controls such as 62 (segment-wise navigation), 58 (Repeat Segment), and 52/60 (Play Segment/Play Next Segment) from FIG. 12 with the Context Subtitles 150 and Context Subtitles Controls for Playback and Navigation from FIGS. 15 and 16. For instance, a student can initially play back (or repeat) AV content segment by segment by conveniently activating the button-like controls 52/60 and 58. Once the student navigates to or play/replay a segment that differs from the current segment or subsequent segment, he/she may decide to use the Context Subtitles with their associated segment-wise Playback and Navigation controls for that purpose. It should also be noted that the remote/handheld device 290 in FIG. 29 makes use of this combination of user controls and context subtitles.

It should be understood that while the foregoing illustrates numerous embodiments of the present invention those embodiments are only exemplary examples only. They are not intended to be exhaustive or to limit the invention to the precise forms disclosed, and obviously many modifications and variations are possible in light of the above teachings. Others who are skilled in the applicable arts will recognize numerous modifications and adaptations of the illustrated embodiments that remain within the principles of the present invention. Therefore, the present invention is to be limited only by the appended claims.

What is claimed:

1. A set of ordered learning segments, comprising:
a length of audio-visual content extending from a start time to an end time;
a set of meta data information associated with said audio-visual content, said meta data information organized as individual meta data segments each of which comprises a beginning time stamp for identifying where in said audio-visual content said meta data segment is associated;
wherein at least one meta data segment contains information related to learning a section of said AV content.

2. The set of ordered learning segments according to claim 1, wherein said meta data information is stored in a database.

3. The set of ordered learning segments according to claim 2, wherein said meta data information is searchable using Structured Query Language commands.

4. The set of ordered learning segments according to claim 1 wherein said audio-visual content and said meta data information are stored in different physical locations.

5. The set of ordered learning segments according to claim 1 wherein said meta data information is time synchronized with said audio-visual content.

6. The set of ordered learning segments according to claim 1, wherein an end of a first meta data segment extends beyond said beginning time-stamp of a second meta data segment.

7. The set of ordered learning segments according to claim 6, wherein said time synchronized meta data information ramps a playback parameter up when beginning a learning segment.

8. The set of ordered learning segments according to claim 6, wherein said time synchronized meta data information ramps a playback parameter down when ending a learning segment.

9. The set of ordered learning segments according to claim 1, wherein said audio-visual content includes I-frames and wherein the first video frame associated with a meta data segment is an I-frame.

10. The set of ordered learning segments according to claim 2, wherein said at least one meta data segment includes information provided by a user community.

11. The set of ordered learning segments according to claim 2, wherein said at least one meta data segment includes a pointer to other data.

12. The set of ordered learning segments according to claim 11, wherein said other data includes Audio content.

13. An Audio Visual Learning system, comprising:
AV memory storage for storing AV content;
meta data memory storage for storing a set of meta data segments; and
a media player with a video display and operatively connected to said AV memory storage to receive said AV content and to said meta data memory storage to receive said meta data;
wherein said media player plays AV content continuously in a continuous play mode;
wherein said media player plays both AV content and meta data segments by meta data segments in a Stop-and-Go mode;
wherein said media player provides a Continuous play mode control when in said continuous play mode; and
wherein said media player provides a Stop-and-Go mode control when in Stop-and-Go mode.

14. The Audio Visual Learning system according to claim 13, wherein said media player comprises a Stop-and-Go mode control in a list including: a Play Segment, Segment control, a Play Next Segment control, a Repeat Segment control, a Skip/Navigate Segment control, and a Segment Text control.

15. The Audio Visual Learning system according to claim 13, wherein said media player includes a Context Subtitle control that causes said media player to display meta data segments around the current meta data segment.

16. The Audio Visual Learning system according to claim 15, wherein said Context Subtitle control enables a user to navigate through and playback Meta Data Segments.

17. The Audio Visual Learning system according to claim 13, wherein said media player comprises a video display screen device for said video display and a remote device for showing a control selected from a list consisting of a Continuous Play Mode control, a Stop-and-Go mode control, and a text entry control.

18. The Audio Visual Learning system according to claim 17, wherein said remote device displays a soft keyboard for text entry.

19. The Audio Visual Learning system according to claim 16, wherein when said Context Subtitle control is activated a subtitle box appears as an overlay on said video display.

20. The Audio Visual Learning system according to claim 13, wherein said meta data includes a word-for-word translation and a phonetic transcription of spoken content.

21. The Audio Visual Learning system according to claim 13, wherein said media player includes a textbox and wherein Stop-and-Go control is a Dictation Mode Control that changes said textbox from displaying subtitles into a text entry box for text entry.

22. An Audio Visual Learning system, comprising:
a media player for playing an ordered set of learning segments comprised of audio-visual content that extends from a start time to an end time and for playing meta data segments associated with the audio-visual content such that the meta data segments are organized as a sequence of individual meta data segments having a beginning time stamp for identifying where in the audio-visual content the meta data segment is associated.

23. The Audio Visual Learning system according to claim 22, wherein said media player can play meta data segments in their sequence order and can navigate through meta data segments.

24. The Audio Visual Learning system according to claim 22, further including a meta data database for storing meta data segments and wherein said media player can play meta data segments based on database queries.
